(19) United States
(12) Patent Application Publication
(10) Pub. No.: US 2024/0118989 A1
(43) Pub. Date: Apr. 11, 2024

(54) PROACTIVELY PERFORM PLACEMENT OPERATIONS TO PROVIDE RESIZING RECOMMENDATIONS FOR WORKER NODES

(71) Applicant: CloudNatix, Inc., Saratoga, CA (US)

(72) Inventors: Rohit Seth, Saratoga, CA (US); Kenji Kaneda, Cupertino, CA (US); Somik Behera, San Francisco, CA (US); Guangrui Fu, Palo Alto, CA (US); Ruyang Lin, San Francisco, CA (US); Jun Mukai, Mountain View, CA (US)

(21) Appl. No.: 18/373,929

(22) Filed: Sep. 27, 2023

Related U.S. Application Data
(60) Provisional application No. 63/413,613, filed on Oct. 6, 2022.

(51) Int. Cl. G06F 11/34; G06F 9/50; G06F 11/32

(52) U.S. Cl. CPC G06F 11/3457; G06F 9/5083; G06F 11/324

(57) ABSTRACT

Some embodiments provide a novel method for deploying containerized applications. The method of some embodiments deploys a data collecting agent on a machine that operates on a host computer and executes a set of one or more workload applications. From this agent, the method receives data regarding consumption of a set of resources allocated to the machine by the set of workload applications. The method assesses excess capacity of the set of resources for use to execute a set of one or more containers, and then deploys the set of one or more containers on the machine to execute one or more containerized applications. In some embodiments, the set of workload applications are legacy workloads deployed on the machine before the installation of the data collecting agent. By deploying one or more containers on the machine, the method of some embodiments maximizes the usages of the machine, which was previously deployed to execute legacy non-containerized workloads.

### BACKGROUND

In recent years, there has been a surge of migrating workloads from private datacenters to public clouds. Accompanying this surge has been an ever increasing number of players providing public clouds for general purpose compute infrastructure as well as specialty services. Accordingly, more than ever, there is a need to efficiently manage workloads across different public clouds of different public cloud providers.

### BRIEF SUMMARY

Some embodiments provide a novel method for harvesting excess compute capacity in a set of one or more datacenters and using the harvested excess capacity to deploy containerized applications. The method of some embodiments deploys data collecting agents on several machines (e.g., virtual machines, VMs, or Pods) operating on one or more host computers in a datacenter and executing a set of one or more workload applications. In other embodiments, the data collecting agents are deployed on hypervisors executing on host computers. In some embodiments, these workload applications are legacy non-containerized workloads that were deployed on the machines before the installation of the data collecting agents.

From each agent deployed on a machine, the method iteratively (e.g., periodically) receives consumption data that specifies how much of a set of resources that is allocated to the machine is used by the set of workload applications. For each machine, the method iteratively (e.g., periodically) computes excess capacity of the set of resources allocated to the machine. The method uses the computed excess capacities to deploy on at least one machine a set of one or more containers to execute one or more containerized applications. By deploying one or more containers on one or more machines with excess capacity, the method of some embodiments maximizes the usages of the machine(s). The method of some embodiments is implemented by a set of one or more controllers, e.g., a controller cluster for a virtual private cloud (VPC) with which the machine is associated.

In some embodiments, the method stores the received, collected data in a time series database, and assesses the excess capacity by analyzing the data stored in this database to compute a set of excess capacity values for the set of resources (e.g., one excess capacity value for the entire set, or one excess capacity value for each resource in the set). The set of resources in some embodiments include at least one of a processor, a memory, and a disk storage of the host computer on which the set of workload applications execute.

In some embodiments, the received data includes data samples regarding amounts of resources consumed at several instances in time. Some embodiments store raw, received data samples in the time series database, while other embodiments process the raw data samples to derive other data that is then stored in the time series database. The method of some embodiments analyzes the raw data samples, or derived data, stored in the time series database, in order to compute the excess capacity of the set of resources. In some embodiments, the set of resources includes different portions of different resources in a group of resources of the host computer that are allocated to the machine (e.g., portions of a processor core, a memory, and/or a disk of a host computer that are allocated to a VM on which the legacy workloads execute).

To deploy the set of containers, the method of some embodiments deploys a workload first Pod, configures the set of containers to operate within the workload first Pod, and installs one or more applications to operate within each configured container. In some embodiments, the method also defines an occupancy, second Pod on the machine, and associates with this Pod a set of one or more resource consumption data values collected regarding consumption of the set of resources by the set of workload applications, or derived from this collected data. Some embodiments deploy an occupancy, second Pod on the machine, while other embodiments simply define one such Pod in a data store in order to emulate the set of workload applications. Irrespective of how the second Pod is defined or deployed, the method of some embodiments provides data regarding the set of resource consumption values associated with the occupancy, second Pod to a container manager for the container manager to use to manage the deployed set of containers on the machine. These embodiments use the occupancy Pod because the container manager does not manage nor has insight into the management of the set of workload applications.

The method of some embodiments iteratively collects data regarding consumption of the set of resources by the set of containers deployed on the workload first Pod. The container manager iteratively analyzes this data along with consumption data associated with the occupancy, second Pod (i.e., with data regarding the use of the set of resources by the set of workload applications). In each analysis, the container manager determines whether the host computer has sufficient resources for the deployed set of containers. When it determines that the host computer does not have sufficient resources, the container manager designates one or more containers in the set of containers for migration from the host computer. Based on this designation, the containers are then migrated to one or more other host computers.

The method of some embodiments uses priority designations (e.g., designates the occupancy, second Pod as a lower priority Pod than the workload first Pod) to ensure that when the set of resources are constrained on the host computer, the containerized workload Pod will be designated for migration from the host computer, or designated for a reduction of their resource allocations. This migration or reduction of resources, in turn, ensures that the computer resources have sufficient capacity for the set of workload application. In some embodiments, one or more containers in the set of containers can be migrated from the resource constrained machine or have their allocation of the resources reduced.

After deploying the set of containers, the method of some embodiments provides configuration data to a set of load balancers that configure these load balancers to distribute API calls to one or more containers in the set of containers as well as to other containers executing on the same host computer or on different host computers. When a subset of containers in the deployed set of containers is moved to another computer or machine, the method of some embodiments then provides updated configuration data to the set of load balancers to account for the migration of the subset of containers.

Some embodiments provide a method for optimizing deployment of containerized applications across a set of one or more VPCs. The method is performed by a set of one or more global controllers in some embodiments. The method collects operational data from each cluster controller of a VPC that is responsible for deploying containerized applications in its VPC. The method analyzes the operational data to identify modifications to the deployment of one or more containerized applications in the set of VPCs. The method produces a recommendation report for displaying on a display screen, in order to present the identified modifications as recommendations to an administrator of the set of VPCs.

When the containerized applications execute on machines operating on host computers in one or more datacenters, the identified modifications can include moving a group of one or more containerized applications in a first VPC from a larger, first set of machines to a smaller, second set of machines. The second set of machines can be a smaller subset of the first set of machines or can include at least one other machine not in the first set of machines. In some embodiments, moving the containerized applications to the smaller, second set of machines reduces the cost for deployment of the containerized applications by using less deployed machines to execute the containerized applications.

The optimization method of some embodiments analyzes operational data by (1) identifying possible migrations of each of a group of containerized applications to new candidate machines for executing containerized application, (2) for each possible migration, using a costing engine to compute a cost associated with the migration, (3) using the computed costs to identify the possible migrations that should be recommended, and (4) including in the recommendation report each possible migration that is identified as a migration that should be recommended. In response to user input accepting a recommended migration of a first containerized application from a first machine to a second machine, the method directs a first cluster controller set of the first VPC to direct the migration of the first containerized application.

In some embodiments, the computed costs are used to calculate different output values of a cost function, with each output value associated with a different deployment of the group of containerized applications. Some of these embodiments use the calculated output values of the cost function to identify the possible migrations that should be recommended. The computed costs include financial costs for deploying a set of containerized applications in at least two different public clouds (e.g., two different public clouds operated by two different public cloud providers).

The optimization method of some embodiments also analyzes operational data by identifying possible adjustments to resources allocated to each of a group of containerized applications and produces a recommendation report by generating a recommended adjustment to at least a first allocation of a first resource to at least a first container/Pod on which a first container application executes.

Some embodiments provide a resizing method that optimizes placement of machines (e.g., Pods) within a cluster of two or more work nodes (e.g., VMs or host computers) on which the machines are deployed. For several machines that are currently deployed on a current group of work nodes, the resizing method performs a simulation that explores different placement of the machines among different combination of work nodes in view of one or more optimization criteria (such as reduction of the cost of the deployed machines).

The method then generates a report to display (e.g., on a web browser) a first simulated placement of the machines on a first set of work nodes. In the report, the method presents a metric associated with the first simulated placement for an administrator to evaluate to determine whether the first simulated placement should be selected instead of the current placement of the machines. When the first simulated placement is selected, the method then deploys the machines on the first set of work nodes as specified by the first simulated placement.

On the other hand, when the administrator provides input (e.g., through a user interface that displays the report, or through an application programming interface) to modify one or more criteria used for the simulation, the method performs the simulation again to identify a second simulated placement of the machines on a second set of work nodes, and then generates another report to display the second simulated placement of the machines on the second set of work nodes. The first and second set of work nodes can have one or more work nodes in common in such cases.

In some embodiment, the report for a simulated placement (e.g., the first or second placement) presents the simulated placement near the current placement that represents a current deployment of the machines on a group of work nodes. This presentation of the two placements near each other allows an administrator to view how the simulated placement is a more compact placement of the machines on the work nodes than the current placement.

The generated report in some embodiments also includes another presentation that displays amounts of resources consumed by the simulated and current placements in order to allow the administrator to view how the simulated placement consumed less resources than the current placement. Alternatively, or conjunctively, the report also includes a presentation that displays a cost of the simulated placement and a cost of the current placement in order to allow the administrator to view how the simulated placement is less expensive than the current placement.

In some embodiments, the deployed machines include Pods, while the work nodes include virtual machines (VMs) or host computers. However, in other embodiments, the machines include VMs and the work nodes include host computers, or the machines include containers and the work nodes include Pods or VMs.

In some embodiments, the resizing method uses a scheduler to perform auto-resizing operations based on a schedule that is automatically determined by the method or specified by an administrator. For instance, the method of some embodiments manages a set of one or more clusters of work nodes deployed in a set of one or more virtual private clouds (VPCs), with each work node executing one or more sets of machines (e.g., one or more Pods operating on one or more VMs). This method is performed by a global controller cluster that operates at one VPC to collect and analyze data from local controller clusters of other VPCs.

Through a common interface, the method collects event data regarding various work nodes deployed in the set of VPCs. The method passes the collected event data through a mapping layer that maps all the data to a common set of data structures for processing to present a unified view of the work nodes deployed across the set of VPCs. Through the scheduler, the method in some embodiments receives a schedule that specifies a time, as well as a series of operations for, adjusting the number of worker nodes and/or Pods, and/or dynamically moving the Pods among operating work nodes in order to optimize the deployment of the Pods on the work nodes as the number of work nodes increases or decreases. In some embodiments, the method receives the time component of the schedule from an administrator.

Conjunctively, or alternatively, the method in some embodiments receives this time component from a deployment analyzer of the scheduler. This deployment analyzer performs an automated process to produce this schedule. For example, the deployment analyzer in some embodiments analyzes historical usages of work nodes, machines executing on the work nodes, and/or clusters to identify a set of usage metrics for the nodes, machines and/or clusters, and then derives a schedule for resizing the clusters, work nodes and/or number of Pods operating on each work node.

Through the common interface, the method in some embodiments directs per the schedule a set of controllers associated with the set of work nodes (e.g., a cluster of local controllers at each affected VPC) to adjust the number of work nodes in each affected cluster and/or to dynamically move the Pods among the operating work nodes. In some embodiments, the schedule specifies a first time period during which the number of work nodes should be reduced, e.g., due to an expected drop in the load on the Pods (e.g., decrease in the traffic to the Pods) deployed on the work nodes. The schedule in some embodiments also specifies a second time period during which the number of work nodes should be increased due to an expected rise in the load on the Pods (e.g., increase in the traffic to the Pods) deployed on the work nodes. The first and second time periods in some embodiments can be different times in a day or different days in the week.

At a first time before a first time period during which the schedule specifies that the number of work nodes should be reduced, the method executes a placement process (e.g., at the global controller) to identify a first new work-node placement for at least a subset of the Pods operating on existing work nodes in order to reduce the number of work nodes that are operating during the first time period. After the placement process identifies the first new work-node placement, the method (e.g., the global controller) directs with communication through the interface any VPC local controller cluster that has to perform an action (e.g., shutdown an existing work node, to add a new work node or to move a Pod to a new work node) to effectuate the first new work-node placement. The communication for the first new work-node placement specified also directs in some embodiments one or more VPC local controller clusters to terminate a subset of Pods that are performing redundant operations that are forecast to be adequately performed during the first time period by another subset of Pods that will remain operational during the first time period.

At a second time during the first time period, the method executes a placement process (e.g., at the global controller cluster) to generate a second new work-node placement for a group of Pods in order to provide the Pods with more resources (e.g., more work nodes) during a second time period that commences after the first time period. The second new work-node placement can (1) increase the number of work nodes, (2) increase the number of Pods and/or (3) decrease the number of Pods operating on any one work node that is operating during the second time period. The second new work-node placement in some embodiments also specifies that one or more existing or new Pods should be moved to one or more new work nodes that are deployed. After the placement process generates the second new work-node placement, the method communicates through the interface with any local VPC controller cluster that has to perform an action on a work node cluster to effectuate the second new work-node placement. Examples of such actions include deploying new work nodes, deploying a Pod on an existing or new work node, moving a Pod to a new work node, etc.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and the Drawings.

### BRIEF DESCRIPTION OF FIGURES

The novel features of the invention are set forth in the appended claims. However, for purposes of explanation, several embodiments of the invention are set forth in the following figures.

FIGS. 1 and 2 conceptually illustrate two processes that implement the method of some embodiments of the invention.

FIG. 3 illustrates a VPC controller cluster of some embodiments.

FIG. 4 illustrates examples of occupancy Pods that are defined on machines with legacy workloads.

FIG. 5 illustrates a process that is performed in some embodiments to continuously monitor consumption of resources on machines with containerized workloads, and to migrate, or to adjust resource allocations, to the containerized workloads when the process detects a lack of resources for the legacy workloads on these machines.

FIG. 6 illustrates an example of migrating containerized application(s) to free up additional resources for the legacy workload application(s) on the same machine.

FIG. 7 illustrates an example of reducing the allocation of resources to containerized application(s) to free up additional resources for the legacy workload application(s) on the same machine.

FIG. 8 illustrates a process that some embodiments use to pack containerized and legacy workloads on fewer machines in order to reduce expenses associated with the deployment of the machines in one or more public or private cloud.

FIG. 9 illustrates an example of one packing solution performed by the process of FIG. 8.

FIG. 10 illustrates an example of a global controller with a recommendation engine that generates cost simulation results and optimization plans.

FIG. 11 illustrates a process that a recommendation engine of a global controller performs in some embodiments to provide recommendations regarding optimized deployments of workloads and to implement a recommendation that is selected by an administrator.

FIG. 12 illustrates an example of re-deployment of workloads pursuant to a recommendation generated by the recommendation engine.

FIG. 13 illustrates a user interface through which a global controller provides the right-sizing recommendation in some embodiments.

FIG. 14 illustrates a process that the global controller of some embodiments performs iteratively.

FIG. 15 illustrates an example of the placement process identifying for a current placement of 21 Pods, three different simulated placements.

FIGS. 16-18 present an example of one way that some embodiments use to provide resizing recommendations for worker node VMs.

FIG. 19 illustrates an example of a resizing process used by some embodiments of the invention.

FIG. 20 illustrates the architecture for collecting event and resource data from VPC cluster controllers through a common interface of a global controller.

FIG. 21 illustrates an exemplary process that the recommendation engine performs in some embodiments to automatically scale down and then back up a deployment of worker nodes and/or Pods at two different time periods.

FIG. 22 illustrates an example of a resizing operation that is performed to reduce the number of Pods and worker nodes during a less busy second time period after a busier first time period.

FIG. 23 illustrates a process in which the global controller of some embodiments uses the unified view of the data to receive, define and distribute RBAC rules for workloads across multiple VPCs.

FIG. 24 illustrates an example of distributing an RBAC rule to two VPC clusters in two different public clouds of two different public cloud providers.

FIG. 25 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for deploying containerized applications. The method of some embodiments deploys a data collecting agent on a machine that operates on a host computer and executes a set of one or more workload applications. From this agent, the method receives data regarding consumption of a set of resources allocated to the machine by the set of workload applications. The method assesses excess capacity of the set of resources that is available for use to execute a set of one or more containers, and then deploys the set of one or more containers on the machine to execute one or more containerized applications. In some embodiments, the set of workload applications are legacy workloads deployed on the machine before the installation of the data collecting agent. By deploying one or more containers on the machine, the method of some embodiments maximizes the usages of the machine, which was previously deployed to execute legacy non-containerized workloads.

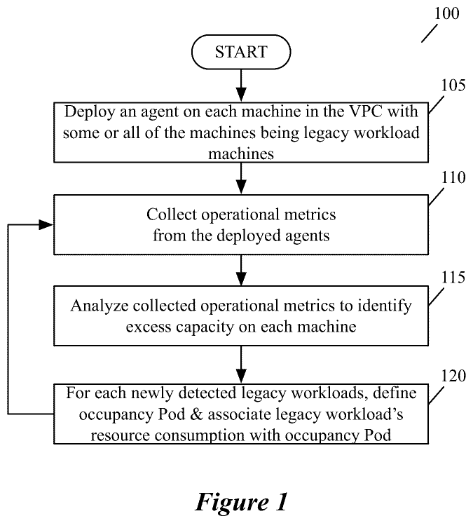

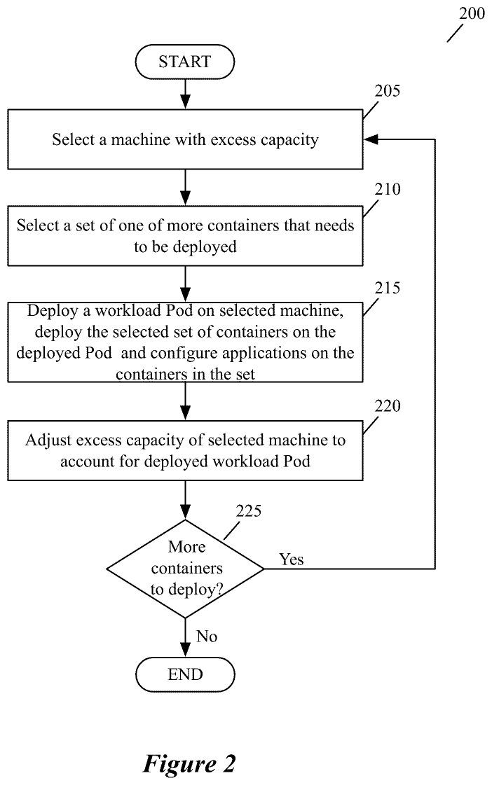

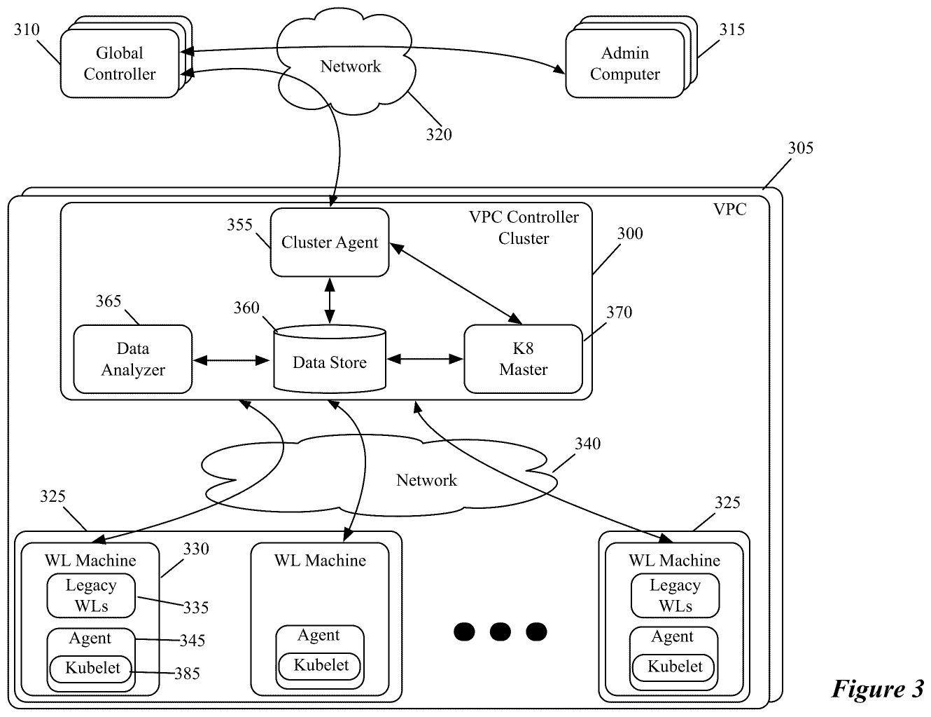

FIGS. 1 and 2 conceptually illustrate two processes 100 and 200 that implement the method of some embodiments of the invention. These processes will be explained by FIG. 3, which illustrates a VPC controller cluster 300 of some embodiments. This controller cluster executes the process 100 of FIG. 1 to harvest excess compute capacity on machines deployed in the VPC 305 and executes the process 200 of FIG. 2 to use the harvested excess capacity to deploy containerized applications on these machines. The illustrations of the processes 100 and 200 is conceptual for some embodiments, as in these embodiments, the operations of these processes are performed by multiple sub-processes.

Multiple VPCs 305 are illustrated in FIG. 3. Each of these VPCs is deployed in a public or private cloud in some embodiments. Each cloud includes one or more datacenters, with the public clouds having datacenters that are used by multiple tenants and the private clouds having datacenters that are used by one entity. As shown, each VPC has its own VPC controller cluster 300 (implemented by one or more controller servers) that communicates with a cluster of global controllers 310.

In some embodiments, a network administrator computer 315 interacts through a network 320 (e.g., a local area network, a wide area network, and/or the internet) with the global controller clusters 310 to specify workloads, policies for managing the workloads, and the VPC(s) managed by the administrator. The global controller cluster 310 then directs through the network 320 the VPC controller cluster 300 to deploy these workloads and effectuate the specified policies.

Each VPC 305 includes several host computers 325, each of which executes one or more machines 330 (e.g., virtual machines, VMs, or Pods). Some or all of these machines 330 execute legacy workloads 335 (e.g., legacy applications), and are managed by legacy compute managers (not shown). The VPC controller cluster 300 communicates with the host computers 325 and their machines 330 through a network 340 (e.g., through the LAN of the datacenter(s) in which the VPC is defined).

Each VPC controller cluster 300 performs the process 100 to harvest excess capacity of machines 330 in its VPC 305. In some embodiments, the process 100 initially deploys (at 105) a data collecting agent 345 on each of several machines 330 in the VPC 305. In some embodiments, the VPC controller cluster 300 has a cluster agent 355 that directs the deployment of the data collecting agents 345 on the machines 330. Some or all of these machines 330 execute legacy workloads 335 (e.g., legacy applications, such as webserver, application servers, database servers). These machines are referred to below as legacy workload machines.

From each deployed agent 345, the process 100 receives (at 110) consumption data (e.g., operational metric data) that can be used to identify the portion of a set of the host-computer resources that is consumed by the set of legacy workload applications that execute on the agent's machine. In some embodiments, the set of host-computer resources is the set of resources of the host computer 325 that has been allocated to the machine 330. When multiple machines 330 execute on a host computer 325, the host computer's resources are partitioned into multiple resources sets with each resource set being allocated to a different machine. Examples of such resources include processor resources (e.g., processor cores or portions of processor cores), memory resources (e.g., portion of the host computer RAM), disk resources (e.g., portion of non-volatile semiconductor or hard disk storage), etc.

Each deployed agent 345 in some embodiments collects operational metrics from an operating system of the agent's machine 330. For instance, in some embodiments, the operating system of each machine has a set of APIs that the deployed agent 345 on that machine 330 can use to collect the desired operational metrics, e.g., the amount of CPU cycles consumed by the workload applications executing on the machine, the amount of memory and/or disk used by the workload applications, etc. In some embodiments, each deployed agent 345 iteratively pushes (e.g., periodically sends) its collected operational metric data since its previous push operation, while in other embodiments the VPC controller cluster 300 iteratively pulls (e.g., periodically retrieves) the operational metrics collected by each deployment agent since its previous pull operation.

In some embodiments, the cluster agent 355 of the VPC controller cluster 300 receives the collected operational metrics (through a push or pull model) from the agents 345 on the machines 330 and stores these metrics in a set of one or more data stores 360. The set of data stores includes a time series data store (e.g., such as Prometheus database) in some embodiments. The cluster agent 355 stores the received data in the time series data store as raw data samples regarding different amounts of resources (e.g., different amounts of processor resource, memory resource, and/or disk resource that are allocated to each machine) consumed at different instances in time by the workload applications executing on the machine.

Conjunctively, or alternatively, a data analyzer 365 of the VPC controller cluster 300 in some embodiments analyzes (at 115) the collected data to derive other data that is stored in the time series database. In some embodiments, the processed data expresses computed excess capacity on each machine 330, while in other embodiments, the processed data is used to compute this excess capacity. The excess capacity computation of some embodiments uses machine learning models that extrapolate future predicted capacity values by analyzing a series of actual capacity values collected from the machines.

The excess capacity of each machine in some embodiments is expressed as a set of one or more capacity values that express an overall excess capacity of the machine 330 for the set of resources allocated to the machine, or an excess capacity per each of several resources allocated to the machine (e.g., one excess capacity value for each resource in the set resources allocated to the machine). Some embodiments store the excess capacity values computed at 115 in the time series data store 360 as additional data samples to analyze.

In some embodiments, the excess capacity computation (at 115) is performed by the Kubernetes (K8) master 370 of the VPC controller cluster 300. In other embodiments, the K8 master 370 just uses the computed excess capacities to migrate containerized workloads deployed by the process 200 or to reduce the amount of resources allocated to the containerized workloads. In these embodiments, the K8 master 370 directs the migration of the containerized workloads, or the reduction of resource to these workloads, after it retrieves the computed excess capacities and detects that one or more machines no longer have sufficient capacity for both the legacy workloads and containerized workloads deployed on the machine(s). The migration containerized workloads and the reduction of resource to these workloads will be further described below by reference to FIG. 2.

At 120, the process 100 (e.g., the cluster agent 355) defines an occupancy Pod on each machine executing legacy workload (e.g., executing legacy workload applications), and associates with this occupancy Pod the set of one or more resource consumption values (i.e., the metrics received at 110, or values derived from these metrics) regarding consumption of the set of resources by the set of workload applications.

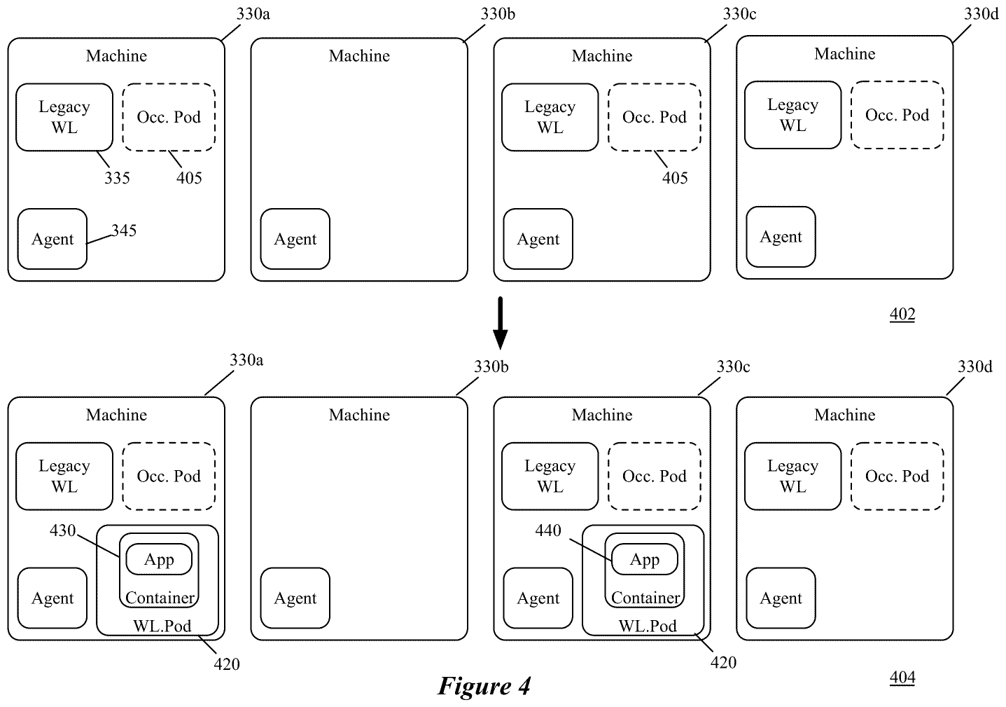

FIG. 4 illustrates examples of occupancy Pods 405 that are defined on machines 330a-d with legacy workloads 335. This figure illustrates two deployment stages 402 and 404 of four machines 330a-d. Three of these machines 330a, 330c, and 330d have occupancy Pods 405. Dashed lines are used to draw the occupancy Pods in this figure in order to illustrate that while these Pods are actually deployed on each machine 330 in some embodiments, in other embodiments they are just Pods that are defined in the data store set 360 to emulate the legacy workloads for the K8 master 370, or for a kubelet 385 that is configured on each agent 345 to operate with the K8 master 370. As described below, the kubelet enforces QoS in some embodiments by reducing allocation of resources or removing lower priority Pods when there is a resource contention (e.g., between legacy workloads and containerized workloads).

Specifically, in some embodiments, the VPC controller cluster 300 deploys the occupancy Pod because neither the K8 manager 370 nor the kubelets 385 manage or have insight into the management of the set of legacy workload applications 335. Hence, the VPC controller cluster 300 uses the occupancy Pod 405 as a mechanism to relay information to the K8 manager 370 and the kubelets 385 regarding the usages of resources by the legacy workload applications 335 on each machine 330. As mentioned above, these resource consumption values are stored in the data store(s) 360 in some embodiments and are accessible to the K8 master 370. The K8 master 370 uses this data to manage the deployed set of containers as mentioned above and further described below.

In some embodiments, the VPC controller cluster 300 uses priority designations (e.g., designates an occupancy Pod 405 on a machine 330 as having a higher priority than containerized workload Pods) to ensure that when the set of resources are constrained on the host computer, the containerized workload Pod will be designated for migration from the host computer, or designated for a reduction of their resource allocations. This migration or reduction of resources, in turn, ensures that the computer resources have sufficient capacity for the set of workload application. In some embodiments, one or more containers in the set of containers can be migrated from the resource constrained machine or have their allocation of the resources reduced.

To compute the excess capacity, the cluster agent 355 of the VPC controller cluster 300 in some embodiments estimates the peak CPU/memory usage of legacy workloads 335 by analyzing the data sample records stored in the time series database 360 and sets the request of the occupancy Pod 405 to the peak usage of legacy workloads 335. The occupancy Pod 405 prevents containerized workloads from being scheduled on machines that do not have sufficient resources due to legacy workloads 335. In some embodiments, the peak usage of legacy workloads 335 is calculated by subtracting the Pod total usage from the machine total usage.

The cluster agent 355 sets the QoS class of occupancy Pods 405 to guaranteed by setting the resource limits, and by setting the priority of occupancy Pods 405 to a value higher than the default priority. Based on these two settings, bias the eviction process of the kubelet 385 operating within each host agent 345 to prefer evicting containerized workloads over occupancy Pods 405. Since both occupancy Pods 405 and containerized workloads are in the guaranteed QoS class, the kubelet 385 evicts containerized workloads, which have lower priority than occupancy Pods 405. The priority of the occupancy Pods is also needed to allow occupancy Pods to preempt containerized workloads that are already running on a machine. Once occupancy Pods become guaranteed, the OOM (ONAP (Open Network Automation Platform) Operation Manager) operating on the machine 330 will prefer evicting containerized workloads over evicting occupancy Pods since the usage of occupancy Pods in some embodiments is close to 0 (just “sleep” process).

As shown in FIG. 1, the process 100 of some embodiments loops through 110-120 (1) to iteratively collect consumption data regarding the amount of the set of resources consumed on each machine by the legacy workloads 335 and by any containerized applications that are newly deployed by the process 200, and (2) to analyze the collected data to maintain up to date excess capacity data and to ensure that any deployed containerized application does not impair the performance of any legacy workloads 335 deployed on the machines 330. In each iteration, the process 100 identifies any newly deployed legacy workloads 335, for which it then defines an occupancy Pod as described above.

FIG. 2 illustrates the process 200 that uses the computed excess capacities of the legacy workload machines in order to select one or more of these machines and to deploy one or more sets of containers on these machines to execute containerized applications. As mentioned above, the process 200 is executed by the VPC controller cluster 300 in some embodiments. In other embodiments, this process is performed by the global controller cluster 310.

The process 200 starts each time that one or more sets of containerized applications have to be deployed in a VPC 305. The process 200 initially selects (at 205) a machine in the VPC with excess capacity. This machine can be a legacy workload machine with excess capacity, or a machine that executes no legacy workloads. In some embodiments, the process 200 selects legacy workload machines so long as such machines are available with a minimum excess capacity of X % (e.g., 30%). When there are multiple such machines, the process 200 selects the legacy workload machine in the VPC with the highest excess capacity in some embodiments.

When the VPC 305 does not have legacy workload machines with the minimum excess capacity, the process 200 selects (at 205) a machine that does not execute any legacy workloads. In some embodiments, the machines that are considered (at 205) by the process 200 for the new deployment are virtual machines executing on host computers. However, in other embodiments, these machines can include BareMetal host computers and/or Pods. At 210, the process 200 selects a set of one or more containers that need to be deployed in the VPC. Next, at 215, the process 200 deploys a workload Pod on the machine selected at 205, deploys the container set selected at 210 onto this workload Pod, and installs and configures one or more applications to run on each container in the container set deployed at 215.

FIG. 4 illustrates the deployment of such workload Pods and containerized applications on these Pods. As mentioned above, the first stage 402 illustrates four machines 330a-d, three of which 330a, 330c, and 330d execute legacy workloads 335, and have an associated occupancy Pod 405, which as mentioned above models the resource consumption of the legacy workloads for the K8 manager 370 and/or its associated the kubelets 385. The second stage 404 of FIG. 4 shows two workload Pods 420 deployed on two machines 330a and 330c. On each workload Pod, a container 430 executes, and an application 440 executes on each container.

At 220, the process 200 adjusts the excess capacity of the selected machine to account for the new workload Pod 420 that was deployed on it at 215. In some embodiments, this adjustment is just a static adjustment of the machine's capacity (as stored on the VPC controller cluster data store 360) for a first time period, until data samples are collected by the agent 345 (executing on the selected machine 330) a transient amount of time after the workload Pod starts to operate on the selected machine. In other embodiments, the process 200 does not adjust the excess capacity value of the selected machine 330, but rather allows for this value to be adjusted by the VPC controller cluster 300 processes after the consumption data values are received from the agent 345 deployed on the machine.

After 220, the process 200 determines (at 225) whether it has deployed all the containers that need to be deployed. If so, it ends. Otherwise, it returns to 205 to select a machine for the next container set that needs to be deployed, and then repeats its operations 210-225 for the next container set. By deploying one or more containers on legacy workload machines, the process 200 of some embodiments maximizes the usages of these machines, which were previously deployed to execute legacy non-containerized workloads.

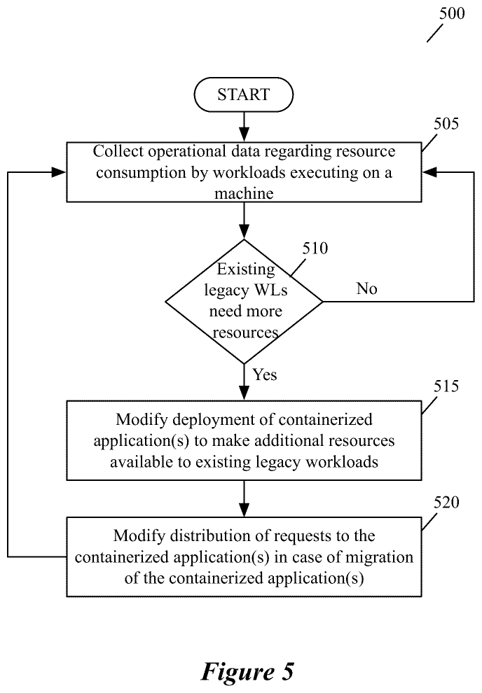

FIG. 5 illustrates a process 500 that is performed in some embodiments to continuously monitor consumption of resources on machines with containerized workloads, and to migrate, or to adjust resource allocations, to the containerized workloads when the process detects a lack of resources for the legacy workloads on these machines. The process 500 is performed iteratively in some embodiments by the K8 master 370 and/or the kubelet 385 of the machine.

As shown, the process 500 collects (at 505) data regarding consumption of resources by legacy and containerized workloads executing on machines in the VPC. At 510, the process analyzes the collected data to determine whether it has identified a lack of sufficient resources (e.g., memory, CPU, disk, etc.) for any of the legacy workloads. If not, the process returns to 505 to collect additional data regarding resource consumption.

Otherwise, when the process identifies (at 510) that the set of resources allocated to a machine are not sufficient for a legacy workload application executing on the machine, the process modifies (at 515) the deployment of the containerized application(s) on the machine to make additional resources available to the legacy workload application. Examples of such a modification include (1) migrating one or more containerized workloads that are deployed on the machine to another machine in order to free up additional resources for the legacy workload application(s) on the machine, or (2) reducing the allocation of resources to one or more containerized workloads on the machine to free up more of the resources for the legacy workload application(s) on the machine.

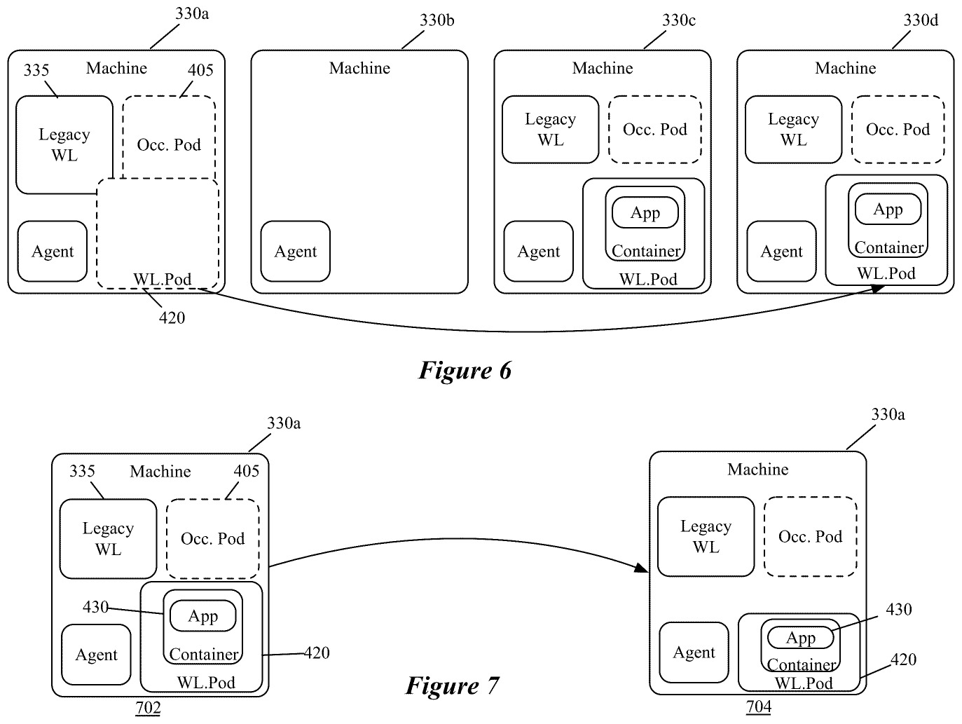

FIG. 6 illustrates an example of migrating containerized application(s) to free up additional resources for the legacy workload application(s) on the same machine. In this example, the legacy workload 335 on machine 330a is consuming more resources (e.g., more CPU, memory and/or disk resources) and this additional consumption does not leave sufficient amount of resources available on the machine 330a for the containerized workload Pod 420. This additional resource consumption is depicted by the larger size of the legacy workloads 335 and its associated occupancy Pod 405 as compared to the representations of these two items in FIG. 4. Because of this additional consumption, the workload Pod 420 has migrated from the machine 330a to the machine 330d, so that the legacy workload 335 can consume additional resources on the machine 330a.

When migrating a containerized application to a new machine, the process 500 moves the containerized application to a machine (with or without legacy workloads) that has sufficient resource capacity for the migrating containerized application. To identify such machines, the process 500 uses the excess capacity computation of the process 100 of FIG. 1 in some embodiments.

FIG. 7 illustrates an example of reducing the allocation of resources to containerized application(s) to free up additional resources for the legacy workload application(s) on the same machine. This figure shows two operational stages 702 and 704 of the machine 330a. The first operational stage 702 shows that as in FIG. 6, the legacy workload 335 on machine 330a in FIG. 7 is consuming more resources (e.g., more CPU, memory and/or disk resources) in the set of resources allocated to the machine 330a, and this additional resource consumption is depicted by the larger size of the legacy workloads 335 and its associated occupancy Pod 405. The second operational stage 704 then shows the workload Pod 420 remaining on the machine 330a but having less resources allocated to it. This reduced allocation level is as depicted by the smaller size of the workload Pod 420 in the second stage 704.

When the process 500 moves the containerized workload to another machine, the process 500 configures (at 520) forwarding elements and/or load balancers in the VPC to forward API (application programming interface) requests that are sent to the containerized application to the new machine that now executes the containerized application. In some embodiments, the migrated containerized application is part of a set of two or more containerized applications that perform the same service. In some such embodiments, load balancers (e.g., L7 load balancers) distribute the API requests that are made for the service among the containerized applications. After deploying the set of containers, some embodiments provide configuration data to configure a set of load balancers to distribute API calls among the containerized applications that perform the service. When a container is migrated to another computer or machine to free up resources for legacy workloads, the process 500 in some embodiments provides updated configuration data to the set of load balancers to account for the migration of the container. After 520, the process 500 returns to 505 to continue its monitoring of the resource consumption of the legacy and containerized workloads.

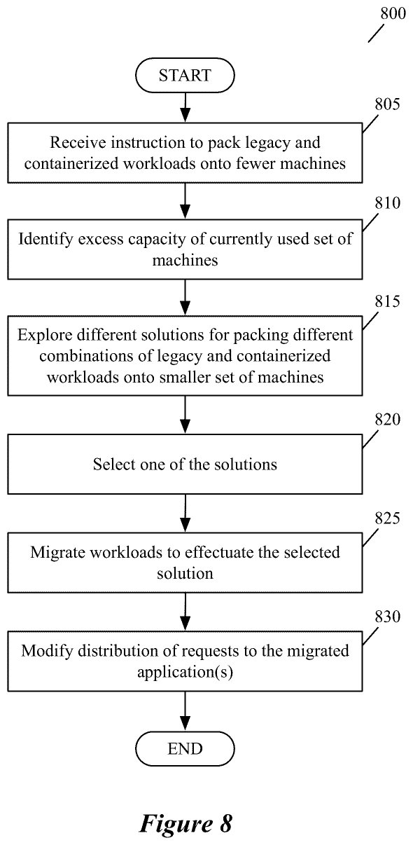

Some embodiments use the excess capacity computations in other ways. FIG. 8 illustrates a process 800 that some embodiments use to pack containerized and legacy workloads on fewer machines in order to reduce expenses associated with the deployment of the machines in one or more public or private cloud. The process 800 is performed by the global controller cluster 310 and the VPC controller cluster(s) 300 of one or more VPCs 305.

As shown, the process 800 starts (at 805) when an administrator directs the global controller cluster 310 through its user interface (e.g., its web interface or APIs) to reduce the number of machines on which the legacy and containerized workloads managed by the administrator are deployed. In some embodiments, these machines can operate in one or more VPCs defined in one or more public or private clouds. When the machines operate in more than one VPC, the administrator's request to reduce the number of machines uses can identify the VPC(s) in which the machines should be examined for the workload migration and/or packing. Alternatively, the administrator's request does not identify any specific VPC to explore in some embodiments.

Next, at 810, the process 800 identifies a set of machines to examine, and for each machine in the set, identifies excess capacity of the set of resources allocated to the machine. The set of machines includes the machines currently deployed in each of the explored VPC (i.e., in each VPC that has a machine that should be examined for workload migration and/or packing). In some embodiments, a capacity-harvesting agent 345 executes on each examined machine and iteratively collects resource consumption data, as described above. In these embodiments, the process 800 uses the collected resource consumption data (e.g., the data stored in a time series data store 360) to compute available excess capacity of each examined machine.

At 815, the process 800 explores different solutions for packing different combinations of legacy and containerized workloads onto a smaller set of machines than the set of machines identified at 810. The process 800 then selects (at 820) one of the explored solutions. In some embodiments, the process 800 uses a constrained optimization search process to explore the different packing solutions and to select an optimal solution from the explored solutions.

The constrained optimization search process of some embodiments uses a cost function that accounts for one or more types of costs. Examples of such costs in some embodiments include resource consumption efficiency cost (meant to reduce the wasting of excess capacity), financial cost (accounting for cost of deploying machines in public clouds), affinity cost (meant to bias towards closer placement of applications that communicate with each other), etc. In other embodiments, the process 800 does not use constrained optimization search processes, but rather uses simpler processes (e.g., greedy processes) to select a packing solution for packing the legacy and containerized workloads onto a smaller set of machines.

After selecting a packing solution, the process 800 migrates (at 825) one or more legacy workloads and/or containerized workloads in order to implement the selected packing solution. The process 800 configures (at 830) forwarding elements and/or load balancers in one or more affected VPCs to forward API (application programming interface) requests that are sent to the migrated workload applications to the new machine on which the workload applications now execute. Following 830, the process 800 ends.

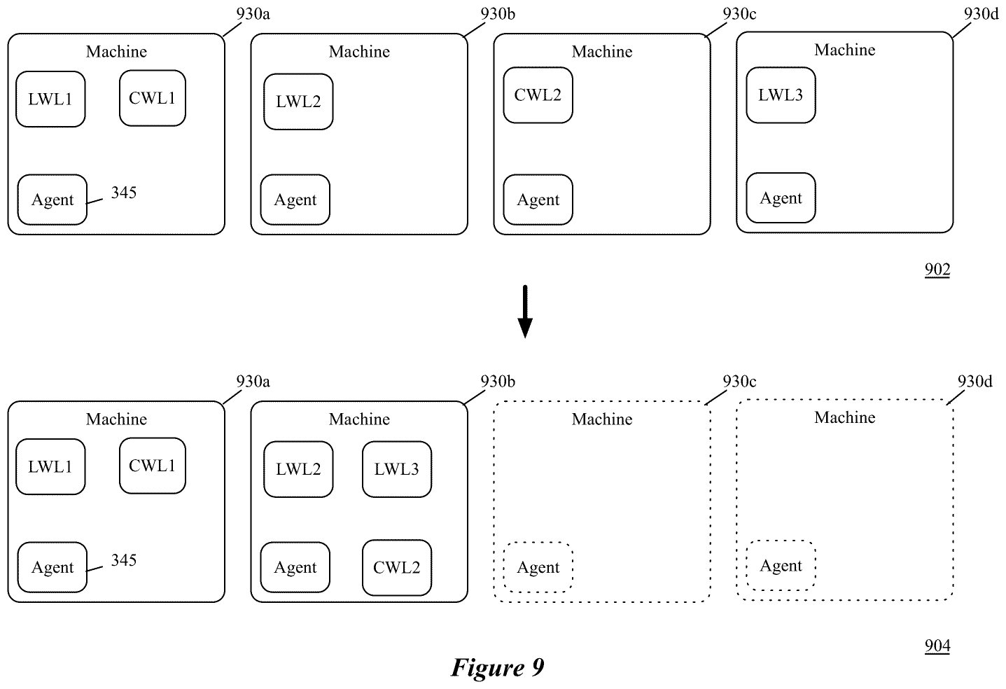

FIG. 9 illustrates an example of one packing solution performed by the process 800. This solution is presented in two operational stages 902 and 904 of four machines 930a-d. Each of these machines executes one or more workloads and a capacity harvesting agent 345. The first stage 902 shows the first machine 930a executing legacy and containerized workloads LWL1 and CWL1, the second machine 930b executing a legacy workload LWL2, the third machine 930c executing containerized workload CWL2, and the fourth machine 930d executing a legacy workload LWL3. The second stage 904 shows that all the legacy and containerized workloads have been packed onto the first and second machines 930a and 930b. This stage depicts the third and fourth machines 930c-d in dashed lines to indicate that these machines have been taken offline as they are no longer used for deployment of any legacy or containerized workload applications.

The packing solution depicted in stage 904 required the migration of the containerized workload CWL2 and the legacy workload LWL3 to the second machine 930b respectively from the third and fourth machines 930c and 930d. Before selecting this packing solution, the process 800 in some embodiments would explore other packing solutions, such as moving the containerized workload CWL2 to the first machine 930a, moving the legacy workload LWL3 to the first machine 930a, moving the containerized workload CWL2 to the fourth machine 930d, moving the legacy workload LWL3 to the third machine 930c, moving the first legacy workload LWL1 and containerized workload CLW1 to one or more other machines, etc. In the end, the process 800 in these embodiments selects the packing solution shown in stage 904 because this solution resulted in an optimal solution with a best computed cost (as computed by the cost function used by the constrained optimization search process).

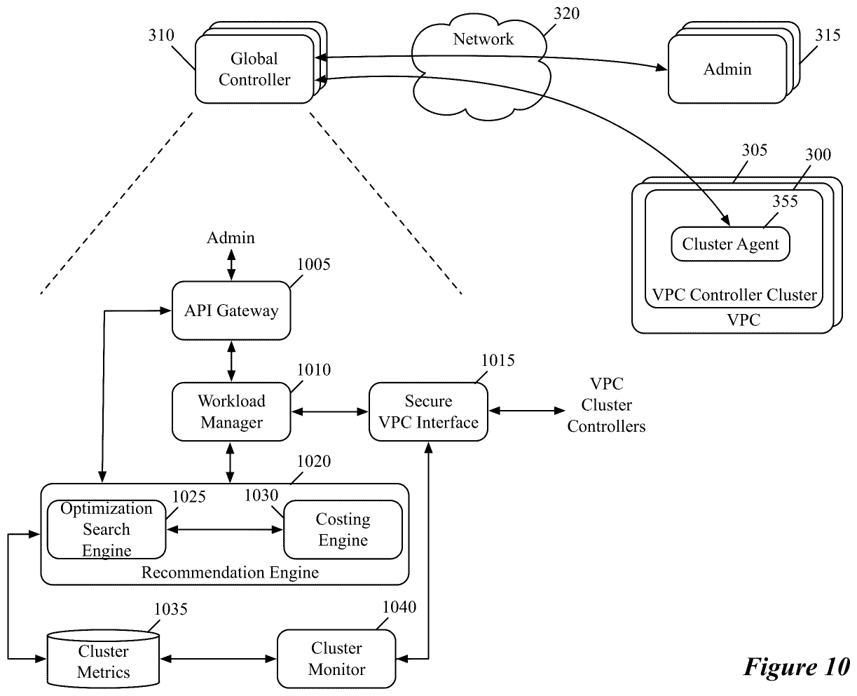

Instead of having a user request the efficient packing of workloads onto fewer machines, or in conjunction with this feature, some embodiments use automated processes to provide recommendations for the dynamic optimization of deployments in order to efficiently pack and/or migrate workloads, and thereby reducing the cost of deployments. FIGS. 10-13 illustrate examples of the dynamic optimization approach of some embodiments.

In these embodiments, the global controller 310 has a recommendation engine that performs the cost optimization. It retrieves historical data from time series database and generates cost simulation results as well as optimization plans. The recommendation engine generates a report that includes these plans and results. The administrator reviews this report and decides whether to apply one or more of the presented plans. When the administrator decides to apply the plan for one or more of the VPCs, the global controller sends a command to the cluster agent of each affected VPC. Each cluster agent that receives a command then makes the API calls to cloud infrastructure managers (e.g., the AWS managers) to execute the plan (e.g., resize instance types).

FIG. 10 illustrates an example of a global controller 310 with a recommendation engine 1020 that generates cost simulation results and optimization plans. In addition to the recommendation engine 1020, the global controller 310 includes an API gateway 1005, a workload manager 1010, a secure VPC interface 1015, a cluster monitor 1040 and a cluster metric data store 1035. The recommendation engine 1020 includes an optimization search engine 1025 and a costing engine 1030.

The API gateway 1005 enables secure communication between the global controller 310 and the network administrator computer 315 through the intervening network 320. Similarly, the secure VPC interface 1015 allows the global controller 310 to have secure (e.g., VPN protected) communication with one or more VPC controller cluster(s) 300 of one or more VPCs 305. The workload manager 1010 of the global controller 310 uses the API gateway 1005 and the secure VPC interface 1015 to have secure communications with the network administrators 315 and VPC clusters 305. Through the gateway 1005, the workload manager 1010 can receive instructions from the network administrators 315, which it can then relay to the VPC controller clusters 300 through the VPC interface 1015.

The cluster monitor 1040 receives operational metrics from each VPC controller cluster 300 through the VPC interface 1015. These operational metrics are metrics collected by the capacity harvesting agents 345 deployed on the machines in each VPC 305. The cluster monitor 1040 stores the received operational metrics in the cluster metrics data store 1035. This data store is a time series database in some embodiments. In some embodiments, the received metrics are stored as raw data samples collected at different instances in time, while in other embodiments they are processed and stored as processed data samples for different instances in time.

The recommendation engine 1020 retrieves data samples from the time series database and generates cost simulation results as well as optimization plans. The recommendation engine uses its optimization search engine 1025 to identify different optimization solutions and uses its costing engine 1030 to compute a cost for each identified solution. For instance, as described above for FIGS. 8 and 9, the constrained optimization search in some embodiments explores different packing solutions and identifies one or more optimal solutions from the explored solutions. Moreover, the costing engine 1030 uses in some embodiments uses a cost function that accounts for one or more types of costs. Examples of such costs in some embodiments include resource consumption efficiency cost (meant to reduce the wasting of excess capacity), financial cost (accounting for cost of deploying machines in public clouds), affinity cost (meant to bias towards closer placement of applications that communicate with each other), etc.

The recommendation engine 1020 generates a report that identifies the usage results that it has identified, as well as the cost simulation and optimization plan that engine has generated. The recommendation engine 1020 then provides this report to the network administrator through one or more electronic mechanisms, such as email, web interface, API, etc. The administrator reviews this report and decides whether to apply one or more of the presented plans. When the administrator decides to apply the plan for one or more of the VPCs, the workload manager 1010 of the global controller 310 sends a command to the cluster agent of the controller cluster of each affected VPC. Each cluster agent that receives a command then makes the API calls to cloud infrastructure managers (e.g., the AWS managers) to execute the plan (e.g., resize instance types).

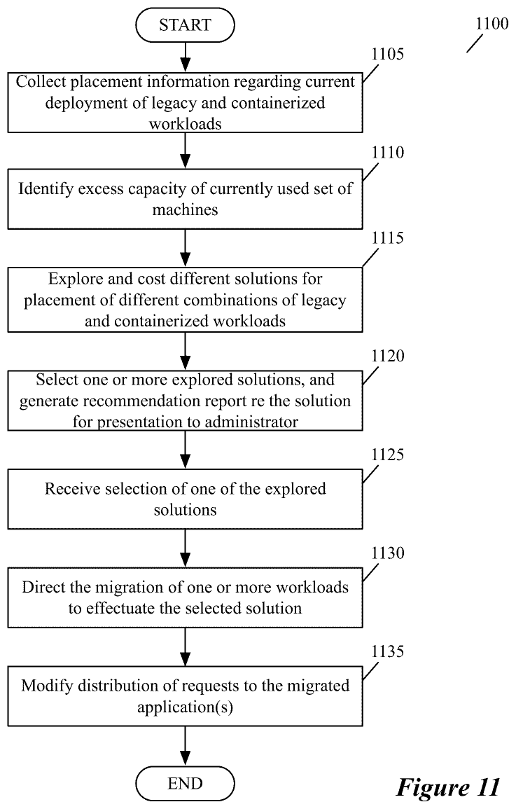

FIG. 11 illustrates a process 1100 that the recommendation engine 1020 of the global controller 310 performs in some embodiments to provide recommendations regarding optimized deployments of workloads and to implement a recommendation that is selected by an administrator. As shown, the process 1100 initially collects (at 1105) placement information regarding current deployment of legacy and containerized workloads. In some embodiments, these machines can operate in one or more VPCs defined in one or more public or private clouds. To perform the operation at 1105, the process 1100 retrieves this data from a data store of the global controller.

Next, at 1110, the process 1100 computes excess capacity of the machines identified at 1105. The process 1100 performs this computation by retrieving and analyzing the data samples stored in the time series database 1035, as described above. For each identified machine in the set, the process 1100 identifies excess capacity of the set of resources allocated to the machine. In some embodiments, a capacity-harvesting agent 345 executes on each examined machine and iteratively collects resource consumption data, as described above. In these embodiments, the process 1100 uses the collected resource consumption data (e.g., the data stored in a time series data store 360) to compute available excess capacity of each examined machine.

At 1115, the process 1100 explores different solutions for packing different combinations of legacy and containerized workloads onto existing and new machines in one or more VPCs. In some embodiments, the search engine 1025 uses a constrained optimization search process to explore the different packing solutions and to select an optimal solution from the explored solutions. The constrained optimization search process of some embodiments uses the costing engine 1030 to compute a cost function that accounts for one or more types of costs. Examples of such costs in some embodiments include resource consumption efficiency cost (meant to reduce the wasting of excess capacity), financial cost (accounting for cost of deploying machines in public clouds), affinity cost (meant to bias towards closer placement of applications that communicate with each other), etc.

The process 1100 then generates (at 1120) a report that includes one or more recommendations for one or more possible optimizations to the current deployment of the legacy and containerized workloads. It then provides (at 1120) this report to the network administrator through one or more mechanisms, such as (1) an email to the administrator, (2) a browser interface through which the network administrator can query the global controller's webservers to retrieve the report, (3) an API call to a monitoring program used by the network administrator, etc.

The administrator reviews this report and accept (at 1125) one or more of the presented recommendations. The recommendation engine 1020 then directs the workload manager 1010 to instruct (at 1130) the VPC controller cluster(s) to migrate one or more legacy workloads and/or containerized workloads in order to implement the selected recommendation. For this migration, the VPC controllers also configures (at 1135) forwarding elements and/or load balancers in one or more affected VPCs to forward API (application programming interface) requests that are sent to the migrated workload applications to the new machine on which the workloads now execute. The process 1100 then ends.

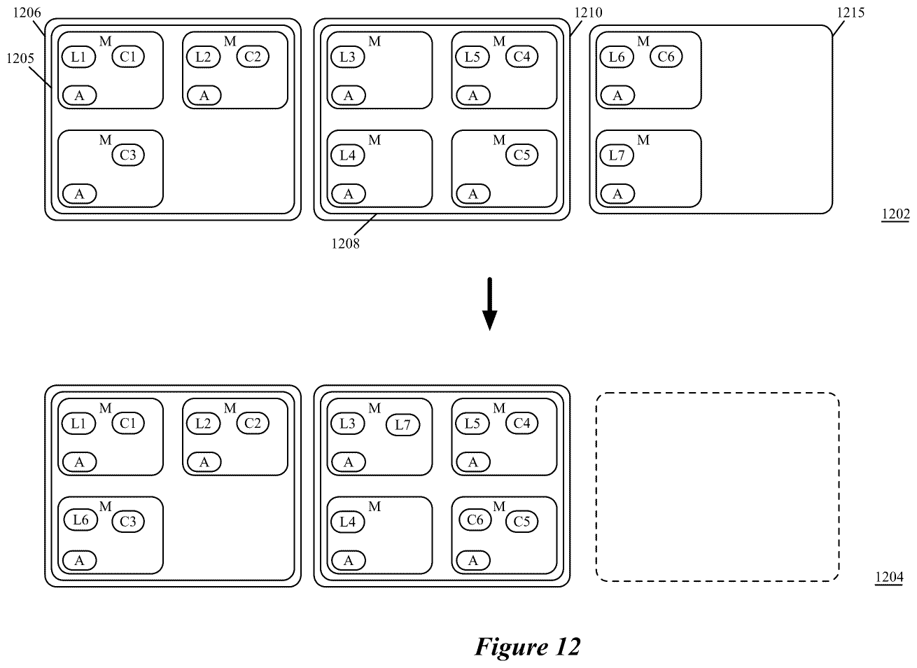

FIG. 12 illustrates an example of re-deployment of workloads pursuant to a recommendation generated by the recommendation engine 1020. This example presents two stages 1202 and 1204 of workload deployments for an entity (e.g., a corporation). Both stages show the workloads deployed on public cloud machines, which in turn execute on host computers (not shown). The workloads include legacy workloads (LWLs) and containerized workloads (CWLs). Each machine is also shown to execute a capacity harvesting agent A.

The first stage 1202 shows that initially a number of workloads for one entity are deployed in three different VPCs that are defined in the public clouds of two different public cloud providers, with a first VPC 1205 being deployed in a first availability zone 1206 of a first public cloud provider, a second VPC 1208 being deployed in a second availability zone 1210 of the first public cloud provider, and a third VPC 1215 being deployed in a datacenter of a second public cloud provider.

The second stage 1204 shows the deployment of the workloads after an administrator accepts a recommendation to move all the workloads to the public cloud of the first public cloud provider. As shown, all the workloads in the third VPC 1215 have migrated to the two availability zones 1206 and 1210 of the first public cloud provider. The third VPC 1215 appears with dashed lines to indicate that it has be terminated. In some embodiments, the migration of the workloads from the third VPC 1215 reduces the deployment cost of the entity as it packs more workloads on the fewer number of public cloud machines, and consumes less external network bandwidth as it would eliminate bandwidth that is consumed by communication between machines in different public clouds of different public cloud providers.

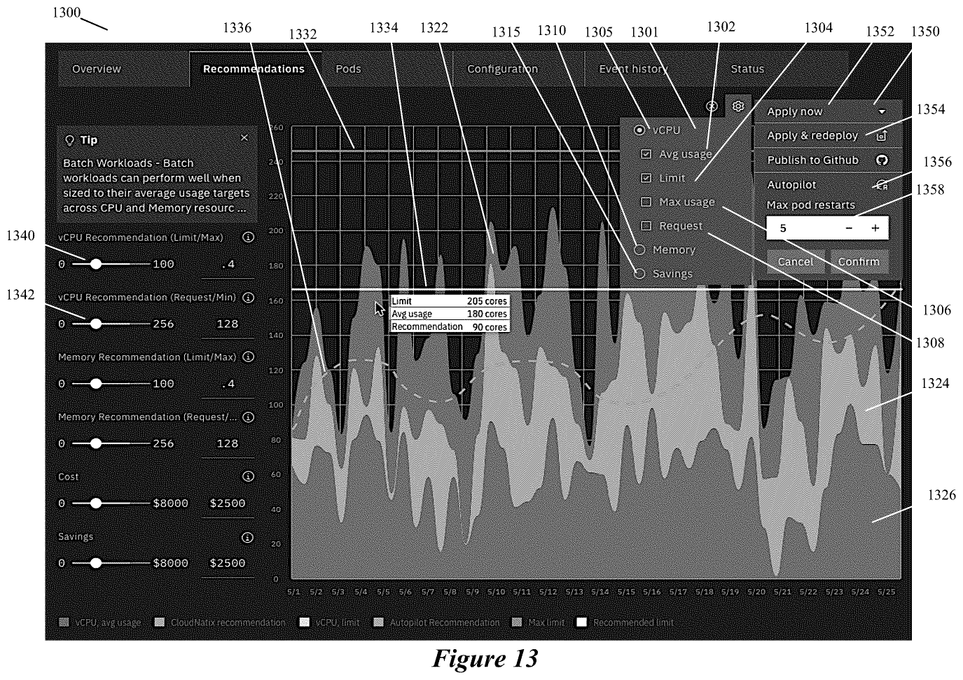

In some embodiments, the global controller provides the right-sizing recommendation via a user interface (UI) 1300 illustrated in FIG. 13. This UI 1300 shows the cost associated with the re-sizing of one workload (e.g., containerized workload) so that a network administrator can assess the impact of optimization. Specifically, the UI 1300 provides controls to see the cost and risk impact of the right-sizing a workload as well as allow the administrator to customize the recommendation before applying. The administrator can then select (e.g., click a button) to apply the recommendation.

In some embodiments, the recommendation engine in the VPC cluster controller communicates with the global controller to apply the recommendations automatically by performing the set of steps a human operator would take in resizing a VM, a Pod, or a container. These steps include non-disruptively adjusting the CPU capacity, memory capacity, disk capacity, GPU capacity available to a container or Pod without requiring a restart.

These steps in some embodiments also include non-disruptively adjusting the CPU capacity, memory capacity, disk capacity, GPU capacity available to a VM with hot resize when supported by underlying Virtualization platforms. In platforms that do not support hot resize, some embodiments ensure the VM's identity and state remain unchanged, by ensuring the VM's OS and data volumes are snapshotted and re-attached to the resized VMs. Some embodiments also persist the VM's externally facing IP or in case of VM Pool, maintain a consistent load balanced IP post resize. In this manner, some embodiments in a closed loop fashion performed all necessary steps to resize VM similar to how a human operator would resize it even when the underlying virtualization platforms do not support hot resize.

In the UI 1300, the administrator can view recommendations versus usage metrics for every several different types of resource consumed by the workload (e.g., the container being monitored). In this example, a window 1301 displays a vCPU resource 1305, and a memory resource 1310, along with a savings option 1315. For the selected vCPU resource 1305, the window 1310 illustrates (1) an average vCPU usage 1302 corresponding to an average observed (actual) usage of the vCPU by the monitored workload, (2) a max vCPU usage 1306 corresponding to a maximum observed usage of the vCPU by the monitored workload, (3) a limit usage 1304 corresponding to a configured maximum vCPU usage for the monitored workload, and (4) a request usage 1308 corresponding to a configured minimum vCPU usage for the monitored workload.

In some embodiments, the UI 1300 also provides visualization of other vCPU usages, such as P99% vCPU usage and P95% vCPU usage, as well as recommended min and maximum vCPU usages. In sum, there are at least three types of usage parameters that the UI 1300 can display in some embodiments. These are configured max and min usage parameters, observed max and min usage parameters and recommended max and min usage parameters. In some of these embodiments, the configured and recommended parameters are shown as straight or curved line graphs, while the observed parameters are shown as waves with solid interiors.

In the example of FIG. 13, the wave 1322 is max observed usage (P100), the wave 1324 is P99 usage (usage that is observed for the 99 percentile), and the wave 1326 is the average usage (also called the P50 usage). An X percentile usage means that X % of the usage samples should be below this given usage number, and only 100−X % of the usage sample are allowed to be higher than PX usage. FIG. 13 also illustrates a configured max usage (limit) 1332, a recommended max usage (limit) 1334, and a recommended max vCPU (limit) 1336 for autopilot mode, which will be described below.

The UI 1300 allows an administrator to adjust the recommended vCPU max and min usages through the slider controls. In this example, the network administrator can adjust the recommended max CPU through the slider 1340 and adjust the recommended min CPU usage through the slider 1342, before accepting/applying the recommendation. As shown, the UI includes sliders for memory max and min usages, as well as cost and saving sliders, which will be described further below.

The UI 1300 allows an administrator to visualize and adjust memory metrics memory option 1310 in the window 1301. Selection of this option enables Memory Resource Metric Visualization, which allows the administrator to visualize recommendations and adjust these recommendations in much the same way as the CPU recommendations can be visualized and adjusted.

The third option 1315 in the window 1301 is the “Savings” option. Enabling this radio button lets the user visualize (1) cost (e.g., money spent) for the configured max CPU or memory resource, (2) cost used (e.g., money spent) for used CPU or Memory resource, and (3) cost recommended (e.g., the recommended amount of money that should be spent) for the recommended amount of resources to consume. The delta between the recommended cost recommended and spent cost is “Savings”. The Cost UI control lets the administrator adjust its target cost and see the controls for CPU/Mem on the left-hand side dynamically move to account for the administrator's desire for a target cost.

When the administrator is satisfied with a recommendation and any adjustment made to the recommendation by the user, the administrator can direct the global controller to apply the recommendation through the Apply control 1350. Selection of this control presents the apply now control 1352, the re-deploy control 1354, and the auto-pilot control 1356. The selection of the apply now control 1352 updates the resource configuration of the machine (e.g., Pod or VM at issue) just-in-time.

When the “apply now” option is selected for a Pod, some embodiments leverage the capacity harvesting agent to reconfigure the Pod's CPU/memory settings. For VMs, some embodiments use another set of techniques to adjust the size just-in-time. For instance, some embodiments take a snapshot of VM's disk, then create a new VM with new CPU/memory settings, attach the disk snapshot and point old VM's public facing IP to the new VM. Some embodiments also allow for scheduled “re-size” of the VM so that the VM can be re-sized during maintenance window of the VM.

The selection of the apply via re-deploy control 1354 re-deploys the machine with new resource configuration. The selection of the auto-pilot control 1356 causes the presentation of the window 1358, which directs the administrator to specify a policy around how many times the machine can be restarted in order to “continuously” apply right-sizing rules. The apply controls 1350 in other embodiments include additional controls such as a dismiss control to show prior dismissed recommendations.

In some embodiments, the recommendations are applicable for a workload, which is the aggregate of the Pods in a set of one or more Pods. The sizes of the Pods in the set of Pods are adjusted using techniques available in K8s and OSS. Some of these techniques are described in https://github.com/kubernetes/enhancements/issues/1287. Some embodiments al so adjust the Pod size via a re-deploy option 1354, or an autopilot with max Pod restart options 1356 and 1358 that iteratively re-deploys until the desired metrics are achieved.

Also, in some embodiments, the right-sizing recommendations computes the CPU/memory savings and modeled cost in order to allow the administrator to assess the financial impact of the right-sizing. Some embodiments: (1) compute the [Cost per VM/2]/[# of CPU MilliCores] and model the cost per MilliCore consumed by a container running on a VM, and (2) take [Cost per VM/2]/[# of Mem. MiB] and model the cost per MiB consumed by a container running on a VM.

The resizing method of some embodiments optimizes placement of machines (e.g., Pods) within a cluster of two or more work nodes (e.g., VMs or host computers) on which the machines are deployed. For several machines that are currently deployed on a current group of work nodes, the resizing method performs a simulation that explores different placement of the machines among different combination of work nodes in view of one or more optimization criteria (such as reduction of the cost of the deployed machines).

The method then generates a report to display (e.g., on a web browser) a first simulated placement of the machines on a first set of work nodes. In the report, the method presents a metric associated with the first simulated placement for an administrator to evaluate to determine whether the first simulated placement should be selected instead of the current placement of the machines. When the first simulated placement is selected, the method then deploys the machines on the first set of work nodes as specified by the first simulated placement.

On the other hand, when the administrator provides input (e.g., through a user interface that displays the report, or through an application programming interface) to modify one or more criteria used for the simulation, the method performs the simulation again to identify a second simulated placement of the machines on a second set of work nodes, and then generates another report to display the second simulated placement of the machines on the second set of work nodes. The first and second set of work nodes can have one or more work nodes in common in such cases.

In some embodiment, the report for a simulated placement (e.g., the first or second placement) presents the simulated placement near the current placement that represents a current deployment of the machines on a group of work nodes. This presentation of the two placements near each other allows an administrator to view how the simulated placement is a more compact placement of the machines on the work nodes than the current placement.

The generated report in some embodiments also includes another presentation that displays amounts of resources consumed by the simulated and current placements in order to allow the administrator to view how the simulated placement consumed less resources than the current placement. Alternatively, or conjunctively, the report also includes a presentation that displays a cost of the simulated placement and a cost of the current placement in order to allow the administrator to view how the simulated placement is less expensive than the current placement.

In some embodiments, the deployed machines include Pods, while the work nodes include virtual machines (VMs) or host computers. However, in other embodiments, the machines include VMs and the work nodes include host computers, or the machines include containers and the work nodes include Pods or VMs.

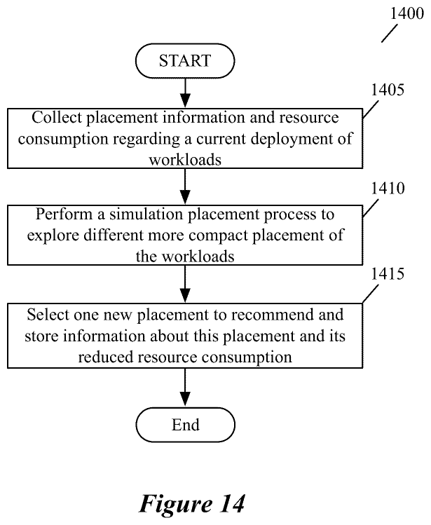

Several more detailed embodiments of the resizing method will now be described by reference to FIGS. 14-19. In these figures, the worker nodes are VMs that execute on host computers in a datacenter, and the machines are Pods that execute on the VMs. Also, the resizing methods illustrated in these examples explore ways to pack Pods onto the VMs in order to reduce the overall number of the VMs and the overall cost of the deployment, while still meeting the constraints (e.g., the service level agreements (SLAs) of the applications running on the Pods).

FIG. 14 illustrates a process 1400 that the global controller 310 of some embodiments performs iteratively (e.g., periodically, such as once every N hours, where N is an integer). As shown, the process 1400 initially collects (at 1405) data from its cluster database 1035 regarding the current placement of several machines on a cluster of worker nodes and collected data regarding the consumption of resources and operational metrics of these machines.

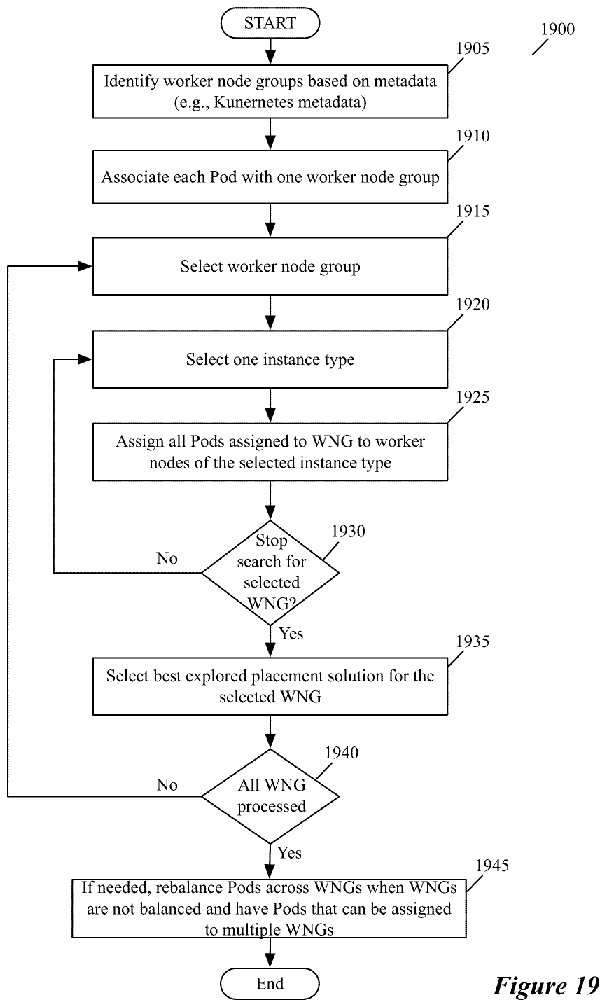

Next, at 1410, the process performs a placement search process to explore different placement of the machines among different combination of work nodes in view of one or more optimization criteria (such as reduction of the cost of the deployed machines). To do this search, the process 1400 uses the optimization search engine 1025 and costing engine 1030 of the recommendation engine 1020 of FIG. 10. Also, one example of the placement search process will be further described below by reference to FIG. 19.

After performing the placement search, the placement process 1400 (at 1415) selects one simulated placement to recommend to an administrator. In some embodiments, the process 1400 selects the simulated placement that produces the lowest overall cost (e.g., lowest financial cost) while meeting the SLA requirements of all the applications running on the Pods. Applications that run on the Pods might need certain amount of compute or network resources, such as certain amount of CPU, memory, storage resources or network resources (e.g., bandwidth resources). When a particular placement cannot provide the required compute or network resources for one or more applications operating on one or more Pods that are placed on worker node VMs, that placement is rejected in some embodiments. In some embodiments, one or more of the constraints can be used to reject a placement solution that the placer identifies even before the placer computes a cost for the placement solution.

After selecting one simulated placement, the placement process stores (at 1415) information about this placement and its reduced resource consumption in a database. The process 1400 in some embodiments uses the stored data to produce a report for an administrator to review. Conjunctively, or alternatively, a user interface (e.g., a web server at the direction of a browser) in some embodiments retrieves the stored data, generates a report based on this data and presents the report to an administrator to review in order to assess whether the selected placement should replace the current placement of the Pods on the worker node VMs.

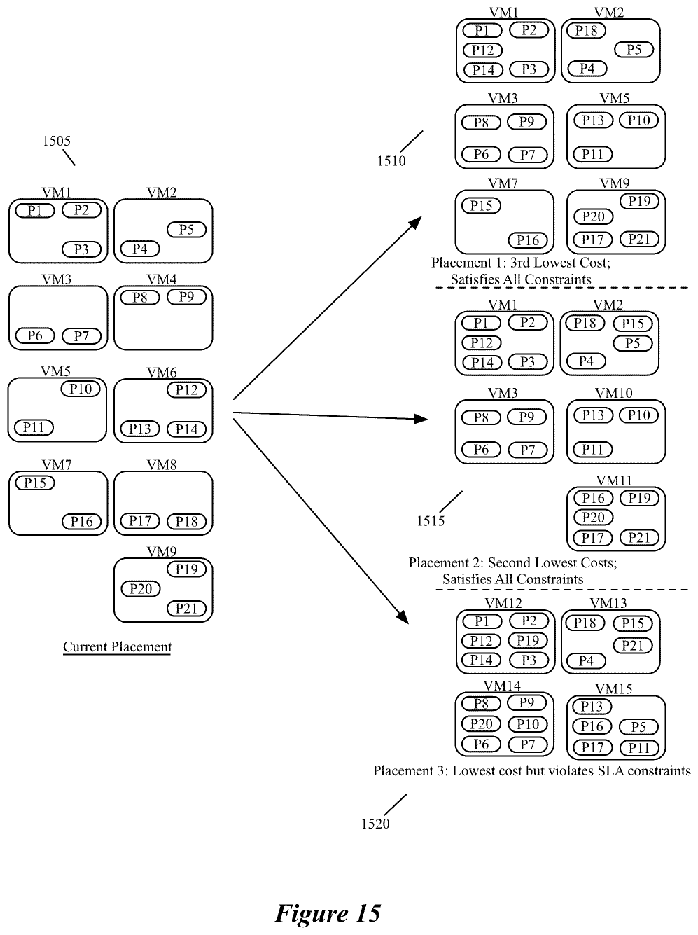

FIG. 15 illustrates an example of the placement process identifying for a current placement 1505 of 21 Pods, three different simulated placements 1510, 1515 and 1520. Each of these three simulated placements is a more compact placement than the current placement 1505 as each simulated placement places the 21 Pods on less than nine VMs, which is the number of worker nodes used in the current placement 1505.

The first simulated placement places the 21 Pods on six VMs (worker nodes), while the second and third simulated placements place these Pods on five and four VMs (worker nodes) respectively. In this example, the first simulated placement 1510 uses a subset of the VMs in the current placement, while the second and third simulated placements 1515 and 1520 use two and four new VMs respectively. In other examples, the simulated placements might only include subset of the VMs that are used for the current placement, while in still other examples the simulated placements might not consider any VMs that are used for the current placement.

As mentioned above, all the simulated placements 1510, 1515 and 1520 have lower deployment costs than the current placement 1505. This lower cost can be due to each of the simulated placements using fewer worker node VMs, these VMs overall consuming less resources than the VMs in the current placement, and/or the type of VMs used in the simulated placements.

The second placement 1515 is the lowest cost placement that satisfies all the constraints including the SLA constraints of the applications operating on the Pods. Again, this lower cost can be due to the reduced number of VMs as well as the type of VMs used and the amount of resources consumed by these VMs in the second placement. The third placement 1520 is the lowest cost placement overall but it fails to meet one or more of the application SLA requirements.

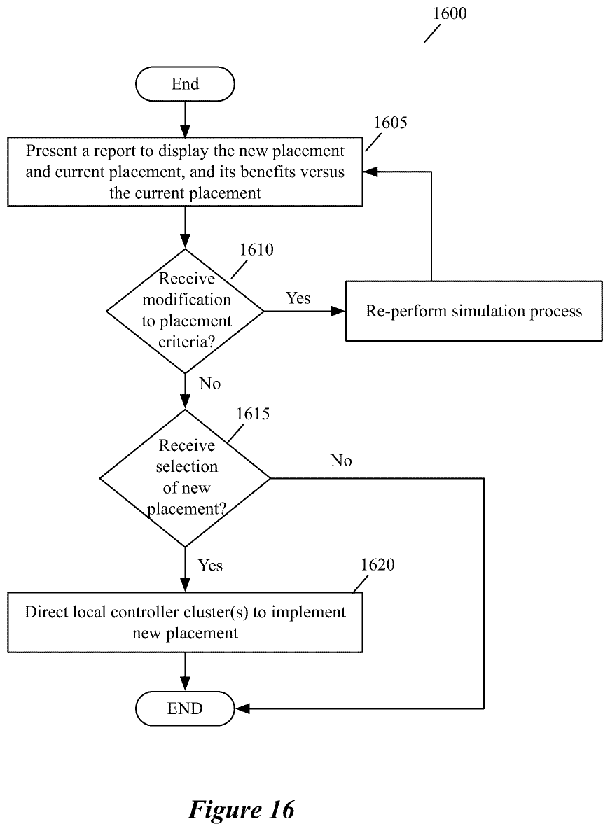

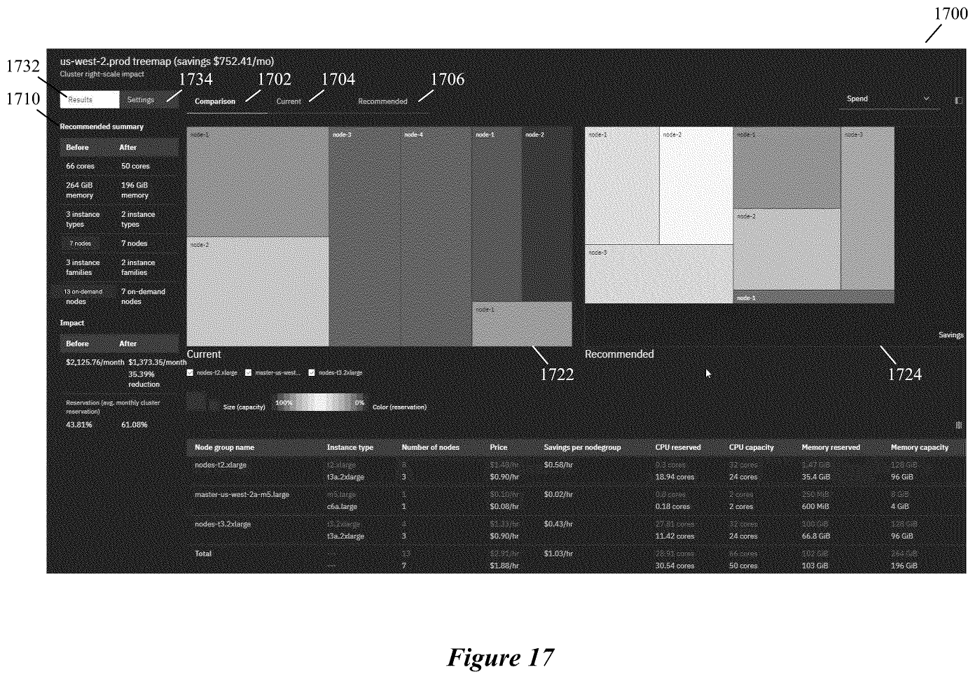

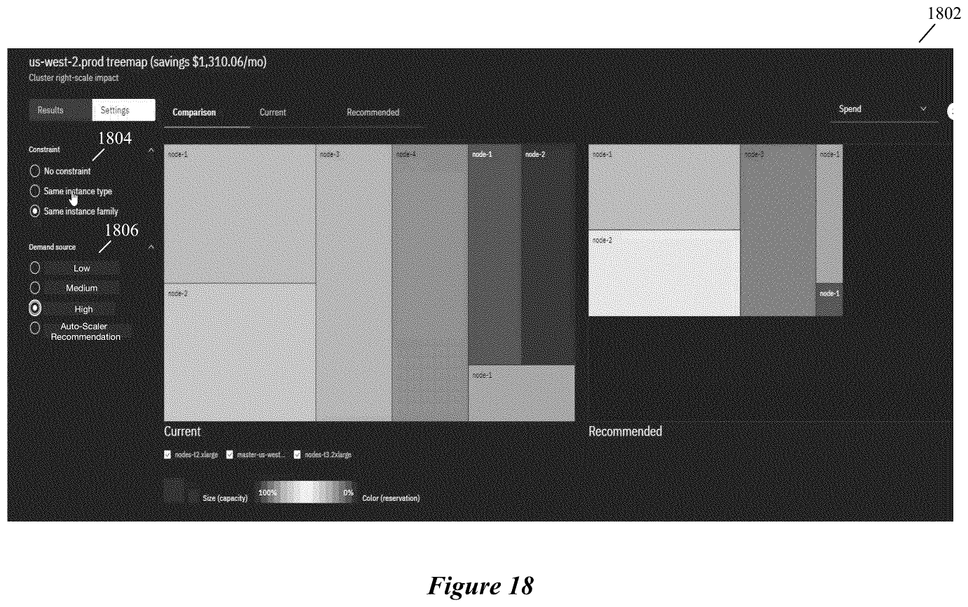

FIGS. 16-18 present an example of one way that some embodiments use to provide resizing recommendations for worker node VMs. FIG. 16 illustrates one process 1600 for interacting with an administrator to provide the resizing recommendation, while FIGS. 17 and 18 illustrate an exemplary UI 1700 for presenting such recommendations, illustrating the benefit of the resizing recommendation, and receiving input from the administrator to use to perform another placement search to identify another recommended placement that would satisfy the user's input.

As shown in FIG. 16, the process 1600 initially presents (at 1605) a report that contains an illustration representing the new placement near an illustration that represents the current placement. In some embodiments, this report also illustrates the benefits of the new placement versus the current placement. The UI 1700 of FIG. 17 includes a comparison tab 1702 that when selected provides representations 1722 and 1724 of the current and recommended placements next to each other. This UI 1700 also has a current tab 1704 and a recommended tab 1706, which when selected respectively provide larger representations of the current placement and the recommended placement.

By viewing these two representations next to each other when the comparison tab 1702 is selected, an administrator can view how the simulated placement 1724 is a more compact placement of a group of machines on the work nodes than the current placement 1722. In this example, the recommended, simulated placement 1724 has the same number of worker nodes as the current placement 1722 but in the simulated placement some of the worker nodes have different types and all of the worker nodes consume less resources, as indicated by the smaller rectangular sizes of the worker nodes in the recommended placement 1724. In other cases, the recommended placement would use less worker nodes and/or less Pods deployed on the worker nodes.

As shown in a summary display pane 1710, the recommended placement consumes 50 processor cores and 196 GB of memory down from 66 processor cores and 264 GB of memory. This display pane 1710 also shows that the recommended placement also uses just two instance types and instance families of worker nodes versus the three instance types and instance families used in the current placement. The summary display pane 1710 further shows that the recommended placement has an expected cost of $1,373.35/month, which is 35.39% less than $2,125.76/month for the current deployment of the machines.

The UI 1700 has a results tab 1732 and a settings tab 1734. When the results tab is selected, the UI presents the summary display pane 1710 described above. On the other hand, when the settings tab 1734 is selected, the UI 1700 presents a settings display pane 1802 that includes several instance constraint settings 1804 and several performance constraint settings 1806, as shown in FIG. 18. The instance constraint settings 1804 allow the administrator to select a (1) no instance constraint, (2) a same instance type constraint specifying that only worker nodes of the same instance type be used, and (3) a same instance family constraint specifying that only worker nodes of the same instance family be used.

The performance constraint settings 1806, on the other hand, allow the administrator to specify how aggressive the simulated placement search should be in packing the Pods onto worker nodes. In this example, the settings are low, medium, and high as well as a setting that is recommended by an auto scaler, which is an automated analysis process used by the recommendation engine to derive an optimal packing setting.

In other embodiments, the UI 1700 provides other instance constraint settings, other placement constraint settings, and/or other types of constraints settings. Also, in other embodiments, the UI provides other presentations to show the resizing of the workers nodes and/or the re-packing of Pods on the worker nodes. For instance, in some embodiments, the UI presentations not only shows the worker nodes in the current and recommended placements but also shows the Pods on these worker nodes, e.g., to show how more Pods are packed on fewer worker nodes in the recommended placement.

After presenting the report comparing the current and recommended placements, the process 1600 of FIG. 16 may receive at 1610 a modification to one or more placement criteria that was used to identify the recommended placement, e.g., receiving the administrator's selection of one of the instance constraint settings 1804 or performance constraint settings 1806. If so, the recommendation engine receives this input, generates a new recommended placement based on the revised criteria, and presents (at 1605) the new recommended placement versus the current placement.

When an administrator provides no modification or no further modifications to the placement criteria, the process 1600 then waits (at 1615) until the administrator terminates the interaction (e.g., closes the browser window) or selects the recommended placement as the placement to use to deploy the workload Pods on the worker nodes. If the administrator terminates the interaction, the process 1600 ends. Otherwise, when the administrator selects the recommended placement for deployment, the process 1600 has (at 1620) the global controller direct each cluster agent in each affected VPC (i.e., each VPC with a Pod for deployment in the selected recommended placement) to perform the deployment changes (e.g., to move Pods, to instantiate new worker nodes, etc.) necessary for implementing the recommended placement. After 1620, the process ends.

FIG. 19 illustrates an example of a resizing process 1900 used by some embodiments of the invention. The process 1900 is invoked in some embodiments for a set of Pods that are currently deployed on a current set of worker nodes in a VPC. This process tries to reduce the number of worker nodes that are used to deploy the set of Pods, by packing as many Pods on each worker node in a greedy manner. In its greedy search, the process 1900 first explores the least expensive worker node types that are feasible for deploying the one or more groups of Pods that exist in the deployed set of Pods.

As shown, the process 1900 initially identifies (at 1905) one or more worker node groups to explore. Each worker node group (WNG) will have one or more assigned worker nodes to which one or more Pods will be assigned. In some embodiments, the method identifies the worker node groups by analyzing the metadata (e.g., labels) that are associated with the current set of worker nodes on which the set of Pods are deployed. For instance, if the worker nodes in the current set of worker nodes are associated with one of three different labels, the process 1900 defines (at 1905) three different worker node groups, one for each label.

At 1910, the process 1900 associates each Pod in the deployed set of Pods with one of the newly defined worker node groups. In some embodiments, each Pod is associated with one or more labels. To assign Pods to worker node groups, the process 1900 in some embodiments assigns the Pod to a worker node group that is associated with a label that is also associated with the Pod. When a Pod can be associated with multiple WNGs as the Pod is associated with multiple labels that are in turn associated with the multiple WNGs, the process 1900 assigns the Pod to just one of the candidates WNGs.

Next, the process 1900 selects (at 1915) one worker node group, and then selects (at 1920) one worker node instance type to explore for the selected WNG. In some embodiments, the process 1900 steps through one or more worker node instance types according to an order based on their respective financial cost (e.g., the cost charged by the cloud provider for the type), namely, steps through the instance types from least expensive to most expensive. In some of these embodiments, the process only explores instance types that are feasible candidates for assigning all the Pods that are currently assigned to the selected WNG, while in other embodiments the process only explores the instance types that are feasible candidates for some but not all of the Pods that are currently assigned to the selected WNG.

At 1925, the process then assigns as many Pods to as the worker nodes (e.g., VMs) of the selected instance type in the selected WNG, assuming that at least one Pod can be assigned to at least one worker node. Typically, multiple Pods can be assigned to each worker nodes. The process 1900 assigns to each worker node as many Pods as possible given each worker node's allocated resources, each Pod's resource requirements and/or the SLA requirements of the applications operating on the Pods.

When no more Pods can be assigned to one worker node, the process 1900 selects another worker node to assign one or more of the remaining Pods, and this process continues until all the Pods have been assigned to a worker node. In other words, in assigning the Pods to the worker nodes of the selected instance type, the process will successively define different worker nodes of the selected type, and assign as many Pods to each defined worker node before defining another worker node of the selected type to assign the next batch of Pods. In this manner, the process tries to define as few worker nodes of the selected instance type as possible. In some embodiments, the process 1900 has to assign all Pods that are associated with the selected WNG to just one worker node instance type. In other embodiments, one WNG can have worker nodes of different instance types and hence this WNG's Pods can be assigned to worker nodes with different instance types.

At 1930, the process determines whether it should stop its search for the selected WNG (e.g., are candidate instance types for the Pods assigned to the selected WNG). In some embodiments, the process 1900 stops its search after it has explored all the worker node instance types for the selected WNG. In other embodiments in which the selected WNG's Pods can be assigned to worker nodes of the different instance types, the process 1900 stops exploring the different instance types when it has explored a sufficient number of instance types to produce a placement solution that is deemed to be optimal for all the Pods associated with the selected WNG. In some such embodiments, the stopping criteria can be based on a combination of factors, such as the number of solutions explored and/or the reduction in the incremental improvement in the search cost. The search cost in some embodiments is computed as the number of worker node times the respective cost of the worker node instance type.

When the process 1900 determines that it should not stop it search, the process 1900 returns to 1920 to select another worker node instance type and to repeat its search for worker nodes of this instance type. Otherwise, when the process 1900 determines that it should stop it search for the selected WNG, the process 1900 selects (at 1935) the best placement solution that it identified for the selected WNG through its multiple placement operation iterations at 1925 for the different instance types. In some embodiments, this best placement solution is the one that has the lowest deployment cost, as computed by the number of worker nodes times the cost of each worker node.

After selecting the best placement solution for the selected WNG, the process 1900 determines (at 1940) whether it has processed all WNGs (i.e., whether it has identified placements for the Pods of all the WNGs). If not, the process returns to 1915 to select another WNG and repeat its operations for this selected WNG. Otherwise, when the process 1900 determines that it has processed all WNGs, the process determines whether two or more WNGs have Pods that can be moved between them in order to rebalance the Pods that are assigned to these WNGs.

As mentioned above, a Pod in some embodiments can be assigned to two or more WNGs. Such Pods can be used to rebalance the WNGs. For instance, such rebalancing is beneficial when one WNG has an underutilized worker node while another WNG has a worker node that is near its maximum utilization, and the utilization of these worker nodes can be balanced by moving one or more Pods to the underutilized worker node from the worker node that is near its maximum utilization. Also, such rebalancing is helpful when an underutilized worker node in one WNG can be eliminated by moving its Pods to another WNG's worker nodes that have excess capacity. Accordingly, at 1945, the process determines whether it should rebalance the Pods across two or more WNGs. If so, the process moves one or more of the identified Pods from a more congested WNG to a less congested WNG. After 1945, the process 1900 ends.

The resizing method of some embodiments uses a scheduler to perform auto-resizing operations based on a schedule that is automatically determined by the method or specified by an administrator. For instance, the method of some embodiments manages a set of one or more clusters of work nodes deployed in a set of one or more virtual private clouds (VPCs) 305, with each work node executing one or more sets of machines (e.g., one or more Pods operating on one or more VMs). This method is performed by the global controller cluster 310 that operates at one VPC 305 to collect and analyze data from local controller clusters 300 and/or agents 355 deployed with these local controller clusters 300 of the VPCs 305.

Through a common interface, the method collects data regarding various work nodes deployed in the set of VPCs, with examples of such data including addition of worker nodes, deployment of Pods on the worker nodes, consumption of resources of the worker nodes or on the computers on which the worker nodes execute, etc. The method passes the collected data through a mapping layer that maps all the data to a common set of data structures for processing to present a unified view of the work nodes deployed across the set of VPCs.

Through the scheduler, the method in some embodiments receives a schedule that specifies a time, as well as a series of operations for, adjusting the number of worker nodes and/or Pods, and/or dynamically moving the Pods among operating work nodes in order to optimize the deployment of the Pods on the work nodes as the number of work nodes increases or decreases. In some embodiments, the method receives the time component of the schedule from an administrator.

Conjunctively, or alternatively, the method in some embodiments receives this time component from a deployment analyzer of the scheduler. This deployment analyzer performs an automated process to produce this schedule. For example, the deployment analyzer in some embodiments analyzes historical usages of work nodes, machines executing on the work nodes, and/or clusters to identify a set of usage metrics for the nodes, machines and/or clusters, and then derives a schedule for resizing the clusters, work nodes and/or number of Pods operating on each work node.

Per the schedule, the method in some embodiments directs through the common interface a set of controllers associated with the set of work nodes (e.g., a cluster of local controllers at each affected VPC) to adjust the number of work nodes in each affected cluster and/or to dynamically move the Pods among the operating work nodes. In some embodiments, the schedule specifies a first time period during which the number of work nodes should be reduced, e.g., due to an expected drop in the load on the Pods (e.g., decrease in the traffic to the Pods) deployed on the work nodes. The schedule in some embodiments also specifies a second time period during which the number of work nodes should be increased due to an expected rise in the load on the Pods (e.g., increase in the traffic to the Pods) deployed on the work nodes. The first and second time periods in some embodiments can be different times in a day or different days in the week.

At a first time before a first time period during which the schedule specifies that the number of work nodes should be reduced, the method executes a placement process (e.g., at the global controller) to identify a first new work-node placement for at least a subset of the Pods operating on existing work nodes in order to reduce the number of work nodes that are operating during the first time period. After the placement process identifies the first new work-node placement, the method (e.g., the global controller) directs with communication through the interface any VPC local controller cluster that has to perform an action (e.g., shutdown an existing work node, to add a new work node or to move a Pod to a new work node) to effectuate the first new work-node placement. The communication for the first new work-node placement specified also directs in some embodiments one or more VPC local controller clusters to terminate a subset of Pods that are performing redundant operations that are forecast to be adequately performed during the first time period by another subset of Pods that will remain operational during the first time period.

At a second time during the first time period, the method executes a placement process (e.g., at the global controller cluster) to generate a second new work-node placement for a group of Pods in order to provide the Pods with more resources (e.g., more work nodes) during a second time period that commences after the first time period. The second new work-node placement can (1) increase the number of work nodes, (2) increase the number of Pods and/or (3) decrease the number of Pods operating on any one work node that is operating during the second time period. The second new work-node placement in some embodiments also specifies that one or more existing or new Pods should be moved to one or more new work nodes that are deployed. After the placement process generates the second new work-node placement, the method communicates through the interface with any local VPC controller cluster that has to perform an action on a work node cluster to effectuate the second new work-node placement. Examples of such actions include deploying new work nodes, deploying a Pod on an existing or new work node, moving a Pod to a new work node, etc.

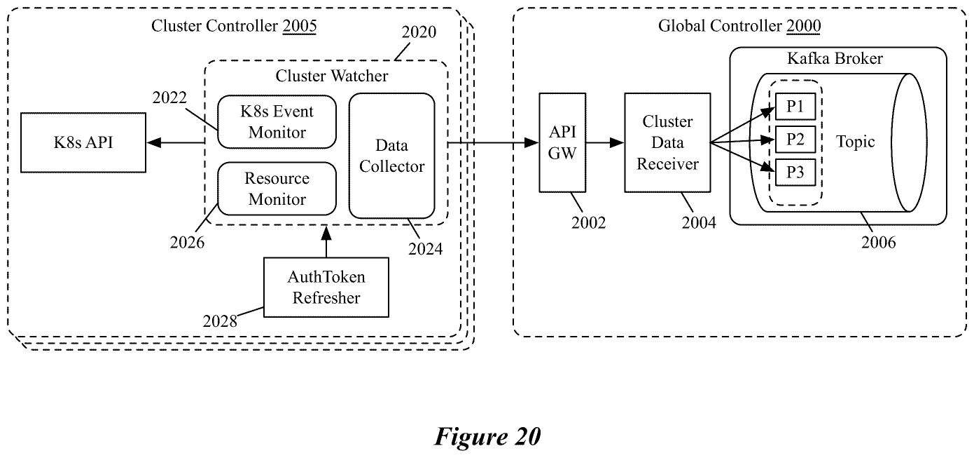

FIG. 20 illustrates the architecture for collecting event and resource data from VPC cluster controllers 2005 through a common interface of a global controller 2000. As shown, this common interface includes an API gateway 2002, a cluster data receiver 2004, and a unified database storage 2006. Each VPC cluster controller 2005 has a cluster watcher 2020, which includes a Kubernetes event monitor 2022, a data collector 2024 and a resource watcher 2026, as well as an authentication token refresher 2028.

Event monitor 2022 collects events that occur on worker nodes in the event monitor's VPC cluster, e.g., by using an informer in the Kubernetes cluster deployment. The resource watcher 2026 collects resource consumption data for the worker nodes. The resource consumption data includes data regarding compute, memory and network resources used by the worker nodes executing on their respective computers.

The authorization token refresher 2028 produces token (e.g., JSON Web Token) for cluster watcher 2020 to use when sending event and resource data to the global controller 2000. The data collector 2024 aggregates the event data and/or resource data, serializes this data, and then forwards the data to the API gateway 2002 using the token(s) obtained from the authorization token refresher 2028. The cluster watcher 2020 is a part of the cluster agent 355 that is deployed in each cluster.

The API gateway 2002 authenticates the forwarded data by using the provided token before forwarding it to the cluster data receiver 2004. The cluster data receiver takes the received data, maps the data to a top level schema and streams it into Kafka event topic of the unified database 2006. In some embodiments, the different topics correspond to the different types of data collected from the VPC clusters.

Some embodiments model application specific data via Pod/Container metric and topology collection by using internal K8s APIs and unify that data with infrastructure specific metrics and topology by talking to cloud service provider (CSP) APIs and resources (be it VM or Platform Services such as RDS), and then injecting the infrastructure cost model into the Global Controller in a unified way across multiple clusters.

The mapping that is done by the global controller 2000 ensures that the data that is collected from the different VPCs that can be deployed in different clouds managed by different cloud providers is specified in a uniform format, on which a uniform set of actions can be performed. Two examples of such uniform operations are the scheduling and role-based access control (RBAC) operations that are described below.

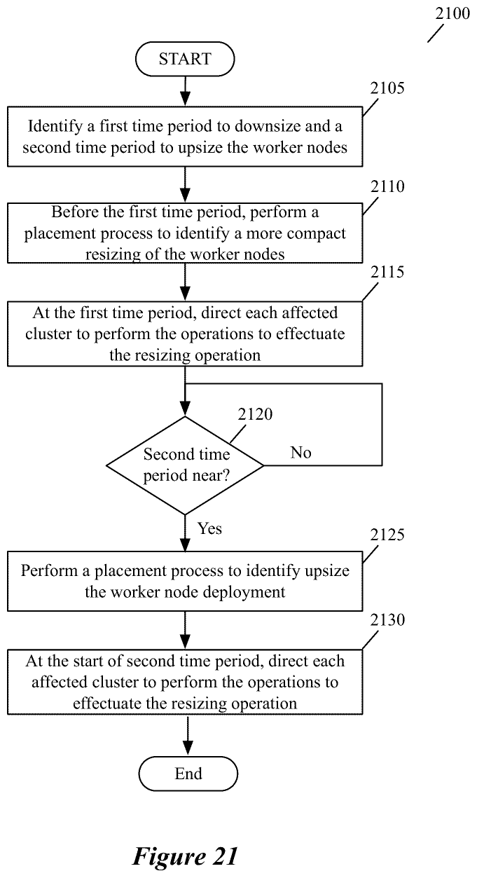

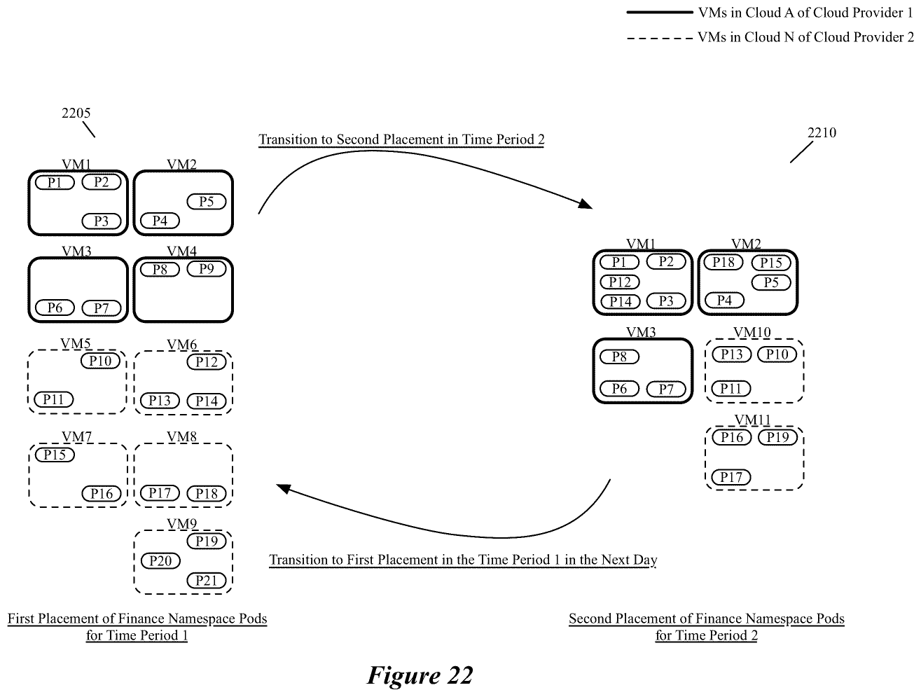

FIG. 21 illustrates an exemplary process 2100 that the recommendation engine performs in some embodiments to automatically scale down and then back up a deployment of worker nodes and/or Pods at two different time periods (e.g., two different times in a day, two different days, etc.). The worker nodes and/or Pods can be in one or more clouds of one or more cloud providers. The process 2100 will be explained by reference the deployment examples illustrated in FIG. 22. Some embodiments perform the process 2100 iteratively (e.g., each day, week, etc.).

As shown, the process 2100 initially identifies (at 2105) first and second time periods for scaling down and scaling up a deployment of machines. The first time period is a time period which the number of work nodes and/or number of Pods should be reduced, e.g., due to an expected drop in the load on the Pods (e.g., decrease in the traffic to the Pods) deployed on the work nodes, while the second time period is a time period during which the number of work nodes and/or number of Pods should be increased due to an expected rise in the load on the Pods (e.g., increase in the traffic to the Pods) deployed on the work nodes. The first and second time periods in some embodiments can be different times in a day, different days in the week or a month, different months in a year, etc.

The time periods are provided by a system administrator that views on a UI (e.g., UI 1700) usage data for several Pods for different times in a day, a week, a month, or a year. Conjunctively, or alternatively, the two time periods are generated by a scheduler of the recommendation engine in some embodiments. In some embodiments, a deployment analyzer of the scheduler analyzes historical usages of work nodes, machines executing on the work nodes, and/or clusters to identify a set of usage metrics for the nodes, machines and/or clusters, and then derives a schedule for resizing the clusters, work nodes and/or number of Pods operating on each work node.

Next, at 2110, the scheduler performs a search to identify and explore different solutions for reducing the number of deployed Pods and/or to pack the deployed Pods onto fewer worker nodes during the first time period, when the load on the Pods is expected to fall. In some embodiments, the scheduler uses historical usage data of the Pods to compute an estimate of the load on the Pods during the first time period. In view of this load, the scheduler explores a number of different deployment solutions, some of which have different number of Pods from each other and from the current deployment of the Pods.

For each explored solution (with a specific number of Pods for deployment), the scheduler explores different placement options for placing the Pods in the solution on different combination of worker node VMs of one or more types in one or more clouds. For each explored placement option for each explored solution of a number of Pods, the scheduler discards the placement option when the option results in one or more applications executing on these Pods not meeting their SLA requirements and/or results in one or more Pods or VMs not having sufficient amount of resources for the required operations of the Pods.

For each placement option that is not discarded, the scheduler computes a cost based on the costs (e.g., financial cost) of the worker nodes for placing the Pods according to the placement option. The scheduler then selects the placement option of the explored solution that results in the best cost (e.g., lowest financial cost). In performing its search, the scheduler can select solutions with worst costs as its current best solution, in order to explore other possible solutions around this current best solution. This approach is a common search technique in order to ensure that the search process does not get stuck in a local minimum that offers a best solution in a particular part of the solution space, when in fact this solution is not the best overall solution but just the best solution in the locality of solutions.

After identifying a placement solution for the first time period at 2110, the scheduler directs (at 2115) a cluster of local controllers at each affected VPC to effectuate the placement solution that the scheduler picked for the first time period. To the controller of each affected VPC, the scheduler directs the controller cluster of that VPC to adjust the number of work nodes in each affected cluster, adjust the number of deployed Pods and/or to dynamically move the Pods among the operating work nodes in order to achieve that VPC's Pod placement according to the placement solution that the scheduler picked for the first time period. Adjusting the number of Pods in a VPC can include terminating the operation of one or more Pods that perform redundant operations that are forecast to be adequately performed during the first time period by another set of one or more Pods that will remain operational during the first time period.

FIG. 22 illustrates an example of a resizing operation that is performed to reduce the number of Pods and worker nodes during a less busy second time period after a busier first time period. In both time periods, several Pods are deployed are several worker node VMs to implement the workloads that are defined in a namespace “Finance” across two cluster of VMs that are deployed in two public clouds managed by two public cloud providers.

The busier first time period has a first pod placement 2205, in which twenty-one Pods operate on four VMs in the first public cloud and five VMs in the second public cloud execute. The resizing operation that is performed for the second time period produces a second Pod placement 2210. This placement 2210 reduces the number of Pods to eighteen, and places these Pods on five worker nodes, two of which (VM10 and VM11) are new with the two new VMs in the second public cloud of the second public cloud provider and the three VMs (VM1-3) in the first public cloud of the first public cloud provider.

After deploying the Pods according to the second Pod placement defined for the second time period, the process 2100 enters a wait state 2120, where it remains until a threshold time period before the second time period. Upon reaching that reachable time period, the process 2100 transitions to 2125, where the global controller executes another placement process to generate another Pod placement for the next iteration of the first time period. This other placement process is designed to provide increase the number of Pods, and/or provide the Pods with more resources (e.g., more work nodes) during this next iteration of the first timer period that commences after the second time period.

The new work-node placement can (1) increase the number of work nodes, (2) increase the number of Pods and/or (3) decrease the number of Pods operating on any one work node that is operating during the next iteration of the first time period. The new placement in some embodiments also specifies that one or more existing or new Pods should be moved to one or more new work nodes that are deployed. After the placement process generates the new placement, the global controller communicates (at 2130) with any local VPC controller cluster that has to perform an action on a work node cluster to effectuate the new placemen. This iteration of the process 2100 then ends.

FIG. 22 illustrates that the resizing operation at the end of the second time period returns to the Pod deployment 2205 for the next iteration of the first time period. In this example, for the next iteration of the first time period, the same number of Pods are deployed to the same worker node VMs as in the previous iteration of the first time period. Returning to the same exact number of Pods on the same exact worker node VMs, however, might not always be possible in some embodiments, as some of the worker node VMs might no longer be operational or not have enough resources to be re-assigned one of the Pods.

Hence, the process 2100 in some embodiments performs (at 2125) the placement search process again for the next iteration of the first time period in order to derive a deployment for the Pods that can satisfy the requirements of the worker node VMs, the Pods and the applications that operate within these Pods. In some embodiments, this placement search process might set the number of Pods to the number used in the prior iteration of the first time period, or it might set it to a different number, e.g., a larger or smaller number of Pods.

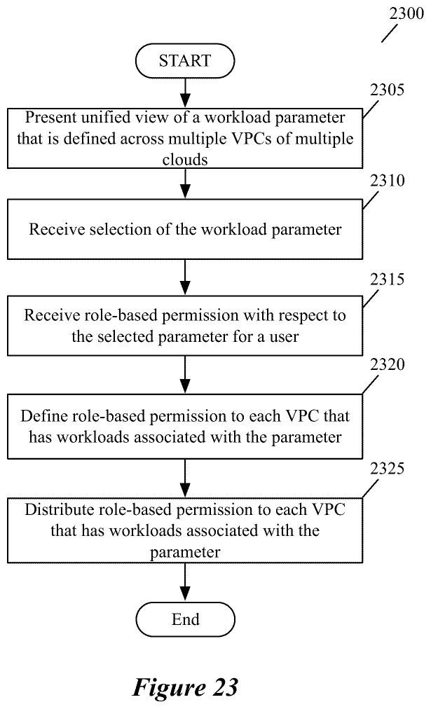

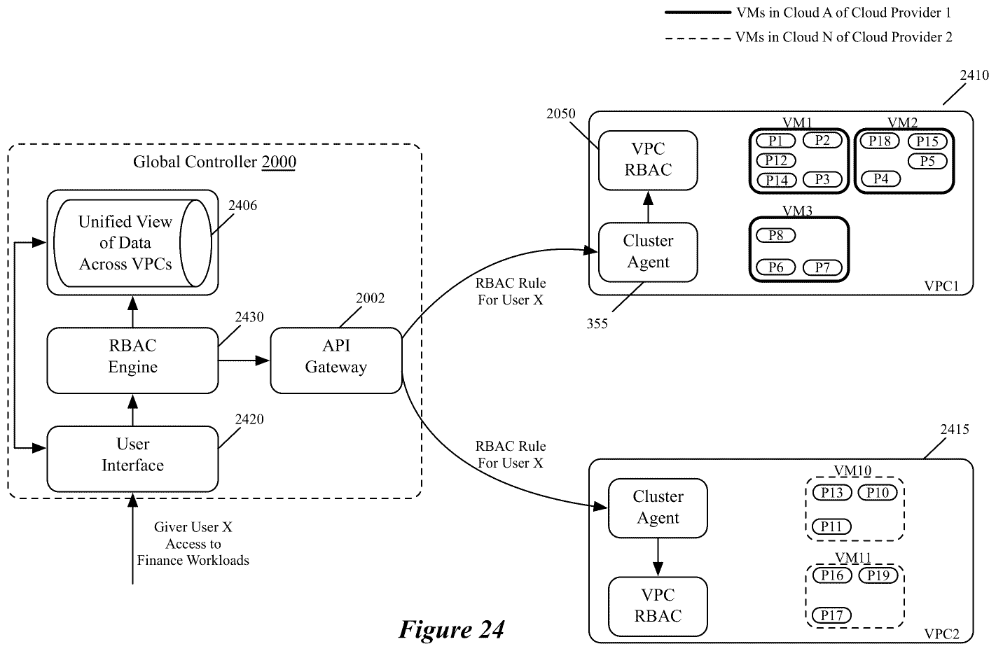

Distributing RBAC rules for workloads that are deployed on different VPCs is another example of an action that the global controller of some embodiments can perform because of the unified view of workloads that it can offer. FIG. 23 illustrates a process 2300 in which the global controller 2000 of some embodiments uses the unified view of the data to receive, define and distribute RBAC rules for workloads across multiple VPCs. This process will be described by reference to the example presented in FIG. 24, which illustrates distributing an RBAC rule to two VPC clusters 2410 and 2415 in two different public clouds of two different public cloud providers.

As shown, the process 2300 starts by presenting (at 2305) a unified view of a workload parameter that is defined across multiple VPCs in multiple clouds managed by multiple cloud providers. This unified view is stored in the database 2406 and is produced by the data import process described above by reference to FIG. 20. One example of a workload parameter that is defined across multiple VPCs is a Namespace under which multiple clusters of workloads are defined in multiple VPCs. In FIG. 24, the Namespace is “Finance” under which twelve Pods are deployed in VPC1 in a cloud of a first cloud provider and six Pods are deployed in VPC2 in a second cloud of a second cloud provider. These eighteen Pods are used to perform operations associated with the Finance department of a company.

At 2310, the process receives a user's selection of the workload parameter in the unified view. As shown in FIG. 24, this selection is through the user interface 2420 of the global controller 2000 in some embodiments. Next, at 2315, the process 2300 receives an administrator request to grant a user X permission to control all workloads defined under the namespace Finance. The process then defines (at 2320) an RBAC rule that is defined by reference to the namespace Finance. This rule grants user X access to all workloads defined under this namespace. In FIG. 24, the RBAC engine 2430 creates the RBAC rule by reference to the data model stored in the database 2406.

At 2325, the process 2300 distributes the generated RBAC rule to the cluster agents 355 deployed in the VPC that has a workload for which the RBAC rule has to be enforced. FIG. 24 illustrates the API gateway 2002 of the global controller 2000 distributing an RBAC rule to the cluster agents 355 for VPC1 and VPC2. This RBAC rule grants user X permission to control all workloads defined under the namespace Finance. All the workloads are Pods in this example. In other examples, some of the workloads are Pods while others are VMs and/or containers. In still other examples, all the workloads are VMs or containers.

The cluster agent in each VPC then uses the APIs of the local managers/controllers in that VPC to provide the RBAC rule to the RBAC engine 2050 for each VPC. Each VPC's RBAC engine then uses this rule to allow user X access to the workloads defined under the namespace Finance in that VPC.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

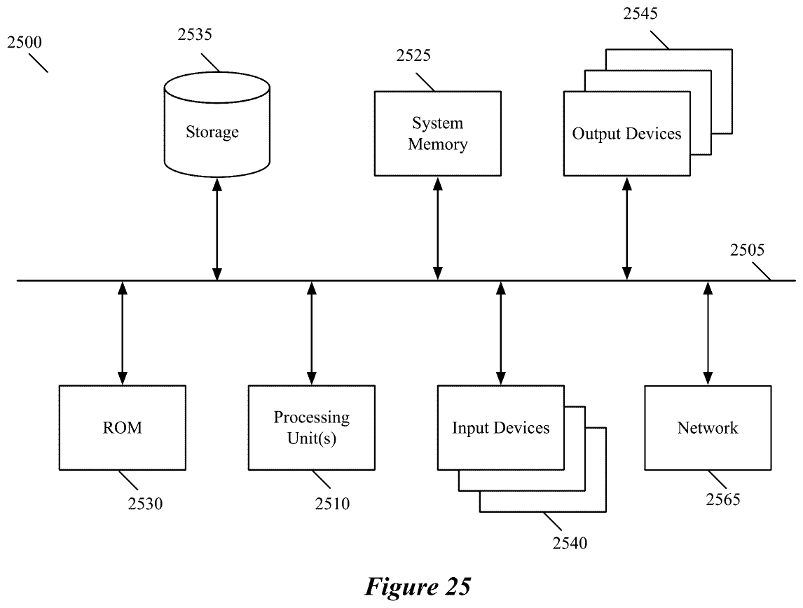

FIG. 25 conceptually illustrates an electronic system 2500 with which some embodiments of the invention are implemented. The electronic system 2500 may be a computer (e.g., a desktop computer, personal computer, tablet computer, server computer, mainframe, a blade computer etc.), or any other sort of electronic device. As shown, the electronic system includes various types of computer readable media and interfaces for various other types of computer readable media. Specifically, the electronic system 2500 includes a bus 2505, processing unit(s) 2510, a system memory 2525, a read-only memory 2530, a permanent storage device 2535, input devices 2540, and output devices 2545.

The bus 2505 collectively represents all system, peripheral, and chipset buses that communicatively connect the numerous internal devices of the electronic system 2500. For instance, the bus 2505 communicatively connects the processing unit(s) 2510 with the read-only memory (ROM) 2530, the system memory 2525, and the permanent storage device 2535. From these various memory units, the processing unit(s) 2510 retrieve instructions to execute and data to process in order to execute the processes of the invention. The processing unit(s) may be a single processor or a multi-core processor in different embodiments.

The ROM 2530 stores static data and instructions that are needed by the processing unit(s) 2510 and other modules of the electronic system. The permanent storage device 2535, on the other hand, is a read-and-write memory device. This device is a non-volatile memory unit that stores instructions and data even when the electronic system 2500 is off. Some embodiments of the invention use a mass-storage device (such as a magnetic or optical disk and its corresponding disk drive) as the permanent storage device 2535.

Other embodiments use a removable storage device (such as a floppy disk, flash drive, etc.) as the permanent storage device. Like the permanent storage device 2535, the system memory 2525 is a read-and-write memory device. However, unlike storage device 2535, the system memory is a volatile read-and-write memory, such a random access memory. The system memory stores some of the instructions and data that the processor needs at runtime. In some embodiments, the invention's processes are stored in the system memory 2525, the permanent storage device 2535, and/or the read-only memory 2530. From these various memory units, the processing unit(s) 2510 retrieve instructions to execute and data to process in order to execute the processes of some embodiments.

The bus 2505 also connects to the input and output devices 2540 and 2545. The input devices enable the user to communicate information and select commands to the electronic system. The input devices 2540 include alphanumeric keyboards and pointing devices (also called “cursor control devices”). The output devices 2545 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 25, bus 2505 also couples electronic system 2500 to a network 2565 through a network adapter (not shown). In this manner, the computer can be a part of a network of computers (such as a local area network (“LAN”), a wide area network (“WAN”), or an Intranet, or a network of networks, such as the Internet. Any or all components of electronic system 2500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

Also, while the excess capacity harvesting agents are deployed on machines executing on host computers in several of the above-described embodiments, these agents in other embodiments are deployed outside of these machines on the host computers (e.g., on hypervisors executing on the host computers) on which these machines operate. Therefore, one of ordinary skill in the art would understand that the invention is not to be limited by the foregoing illustrative details, but rather is to be defined by the appended claims.

1. A method of optimizing placement of a plurality of machines within a cluster of two or more worker nodes on which the machines are deployed, the method comprising:
for the plurality of machines that are deployed on the cluster of worker nodes according to a current placement:
performing a simulation that explores different placement of the machines among different combination of worker nodes;
generating a report to display a first placement of the machines on a first set of worker nodes;
presenting, in the report, a metric associated with the first placement for an administrator to evaluate to determine whether the placement should be selected;
when the first placement is selected, deploying the machines on a group of worker nodes as specified by the first placement.

2. The method of claim 1 further comprising:
receiving input from the administrator to modify one or more criteria used for the simulation;
performing the simulation again to identify a second placement of the machines on a second set of worker nodes;
generating another report to display the second placement of the machines on the second set of worker nodes.

3. The method of claim 2, wherein the first and second set of worker nodes have one or more worker nodes in common.

4. The method of claim 1, wherein the report comprises a presentation that displays the first placement near a second placement that represents a current deployment of the machines on a second set of worker nodes, said presentation of the two placements near each other allowing an administrator to view how the first placement is a more compact placement of the machines on the worker nodes than the second placement.

5. The method of claim 4, wherein the first and second set of worker nodes have one or more worker nodes in common.

6. The method of claim 4, wherein the report further comprises another presentation that displays an amount of resources consumed by the first placement and by the second placement in order to allow the administrator to view how the first placement consumed less resources than the second placement.

7. The method of claim 4, wherein the report further comprises another presentation that displays a cost of the first placement and a cost of the second placement in order to allow the administrator to view how the first placement is less expensive than the second placement.

8. The method of claim 1, wherein the report comprises a set of controls for an administrator to use to specify one or more constraints for re-running the simulation.

9. The method of claim 1, wherein the machines comprise Pods and the worker nodes comprise virtual machines or host computers.

10. The method of claim 1, wherein the machines comprise containers and the worker nodes comprise virtual machines or host computers.

11. The method of claim 1, wherein the machines comprise virtual machines and the worker nodes comprise host computers.

12. A non-transitory machine readable medium storing a program for execution by a set of processing units, the program for optimizing placement of a plurality of machines within a cluster of two or more worker nodes on which the machines are deployed, the program comprising sets of instructions for:
for the plurality of machines that are deployed on the cluster of worker nodes according to a current placement:
performing a simulation that explores different placement of the machines among different combination of worker nodes;
generating a report to display a first placement of the machines on a first set of worker nodes;
presenting, in the report, a metric associated with the first placement for an administrator to evaluate to determine whether the placement should be selected;
when the first placement is selected, deploying the machines on a group of worker nodes as specified by the first placement.

13. The non-transitory machine readable medium of claim 12 further comprising sets of instructions for:
receiving input from the administrator to modify one or more criteria used for the simulation;
performing the simulation again to identify a second placement of the machines on a second set of worker nodes;
generating another report to display the second placement of the machines on the second set of worker nodes.

14. The non-transitory machine readable medium of claim 13, wherein the first and second set of worker nodes have one or more worker nodes in common.

15. The non-transitory machine readable medium of claim 12, wherein the report comprises a presentation that displays the first placement near a second placement that represents a current deployment of the machines on a second set of worker nodes, said presentation of the two placements near each other allowing an administrator to view how the first placement is a more compact placement of the machines on the worker nodes than the second placement.

16. The non-transitory machine readable medium of claim 15, wherein the first and second set of worker nodes have one or more worker nodes in common.

17. The non-transitory machine readable medium of claim 15, wherein the report further comprises another presentation that displays an amount of resources consumed by the first placement and by the second placement in order to allow the administrator to view how the first placement consumed less resources than the second placement.

18. The non-transitory machine readable medium of claim 15, wherein the report further comprises another presentation that displays a cost of the first placement and a cost of the second placement in order to allow the administrator to view how the first placement is less expensive than the second placement.

19. The non-transitory machine readable medium of claim 12, wherein the report comprises a set of controls for an administrator to use to specify one or more constraints for re-running the simulation.

20. The non-transitory machine readable medium of claim 12, wherein the machines comprise Pods and the worker nodes comprise virtual machines or host computers.
